(19) United States
(12) Patent Application Publication
(10) Pub. No.: US 2020/0311845 A1
(43) Pub. Date: Oct. 1, 2020

(54) Inventory Transport Monitoring System

(71) Applicant: Caterpillar Inc., Deerfield, IL (US)

(72) Inventors: Brian B. Steketee, Grand Rapids, MI (US); J.D. Collins, East Grand Rapids, MI (US); Thad Eric Senti, Zeeland, MI (US); Mark James Strayer, Rockford, MI (US); Gregory Nowak, Grand Rapids, MI (US); Daniel P. Bayer, Grand Rapids, MI (US); David W. Baarman, Fennville, MI (US)

(73) Assignee: Caterpillar Inc., Deerfield, IL (US)

(21) Appl. No.: 16/311,082

(22) PCT Filed: Jun. 21, 2017
(86) PCT No.: PCT/US2017/038447

§ 371 Date: Dec. 18, 2018

Related U.S. Application Data
(60) Provisional application No. 62/353,334, filed on Jun. 22, 2016.
(60) Provisional application No. 62/409,432, filed on Oct. 18, 2016.

(51) Int. Cl. G06Q 50/28; G06Q 30/02; G06Q 10/06; G06Q 10/04

(52) U.S. Cl. CPC G06Q 50/28; G06Q 30/0201; G01S 1/042; G06Q 10/04; G06Q 10/06312

(57) ABSTRACT

An inventory transport monitoring system for gathering usage information in a retail store includes a network of sensors and data collection hubs located within the retail store. A plurality of inventory stocking carts are outfitted with nodes for tracking the cart location within the store. The tracking node may track location data and patterns and uses a unique ID that broadcasts monitored data to understand when and where the node has been moved. The usage information is transmitted to the hub for collection and analyzing. The system can use the usage information collected from the individual stores to measure and compare successful stores to failing stores.

### BACKGROUND OF THE INVENTION

The present invention relates to an inventory transport monitoring system for use in the field of retailing, and more particularly to a system that provides information to identify and track successful retail store characteristics and efficiency.

Profitability of a retail store is in part dependent on product placement and availability on shelving. Part of the efficient management of a retail store is ensuring that the shelves are restocked in a timely fashion. It is desirable to keep retail shelves well stocked for a variety of reasons. If there is insufficient stock on the shelf to meet demand, then a sale may be lost. Stocked shelves also help ensure that the store's backroom inventory storage space is being used efficiently, and help a store determine more precisely when to reorder inventory from suppliers. Lastly, stocked shelves contribute to the ambience of a store.

In the past, the effort to manage and track events within a retail establishment or the supply distribution chain has been limited. As technology and the Internet of Things (“IOT”) improve, these opportunities become more visible and affordable. Virtually everything, including heating, ventilating, air conditioning, lighting, and locks, can now be monitored and automated to some degree. Bringing these controls together to manage store profitability can provide a competitive edge and assist in maintaining product on the shelves, which is a factor in the revenue of a retail establishment. The overall understanding of the “cost to serve” generally allows for better management decisions relating to customer experience and profitability.

One problem today with these types of IOT sensors and tags is battery life and powering methods. Adding sensors to all the store shelves becomes an issue if all the sensors require batteries or power, to the point that managing the sensors and replacing batteries may become counterproductive. The issue of battery life prevents remote sensors or assets from being monitored due to the high cost and logistics of maintenance. To be useful, tracking assets that are elements of a running business need low or no maintenance, or the gains made with the sensors may be negated.

Another issue is balancing the time spent performing various tasks within the store. Understanding and identifying which tasks are essential and the optimal time and priority to perform these tasks can be helpful to increase profitability.

Utilizing triangulation or other known tracking techniques can provide some level of tracking, but unfortunately, when there are a large number of objects to be tracked and various other environment issues these techniques can produce false positives at a rate that is too high, consume too much power, or be too costly to implement.

### SUMMARY OF THE INVENTION

The inventory transport monitoring system for a store of the present invention includes hub nodes that are positioned throughout a store. Each of these hub nodes includes a communication system for communicating with tracking nodes that are installed on inventory carts that are used for stocking inventory within the store. Each of the tracking nodes also includes a communication system that is capable of communication with the hub nodes. The information collected from the nodes can be sent to a coordinator node that can relay the information to a database.

In a store environment, such as a retail store, tracking inventory cycles and timing of the inventory carts can provide helpful information. As new inventory enters a store, it can be recorded into an inventory database, and stored, perhaps in a backroom, to await placement on store shelving. Tracking the subtle events and timing of inventory movement can be a valuable tool to create metrics related to the performance of a store, which can be analyzed and used to make changes that make the store more profitable and efficient.

The tracking information provided by the inventory transport monitoring system can be combined with information provided by other systems in order to create additional metrics, which can also be analyzed and used to make changes that make the store more profitable and efficient.

Yet another aspect of the invention includes improving the battery life of the battery powered nodes in the system. The inventory transport monitoring system may eliminate, reduce, or minimize the cost of maintenance related to the battery life of the nodes. Low current, and thus lower battery drain, can be accomplished by time slicing an already low power RF transmission along with timed interrupt based sensor observation over a predefined time period.

Yet another aspect of the invention includes a method for improving a store. The method includes tracking, with an inventory management system, inventory information for each of the plurality of stores. At each store, an item is flagged for restocking in response to inventory information indicating a threshold number of the item has been sold according to a restocking priority scheme. The method further includes tracking with an inventory transport monitoring system at each store, inventory transport characteristics for a plurality of inventory transports at each of the plurality of stores including a restocking route of each inventory transport, categorizing, based on profitability, each of the one or more of the plurality of stores as successful or unsuccessful. The method includes changing at least one characteristic of a store categorized as unsuccessful to correspond to a characteristic of a successful store. For example, the characteristic that is changed may be the restocking priority scheme or the inventory transport restocking routes.

These and other advantages and features of the invention will be more fully understood and appreciated by reference to the description of the current embodiments and the drawings.

### BRIEF DESCRIPTION OF THE DRAWINGS

FIG. 1 illustrates a functional block diagram of one embodiment of an inventory transport monitoring system for a store.

FIG. 2 illustrates a functional block diagram of one embodiment of an inventory transport tracking node for use in an inventory transport monitoring system.

FIG. 3 illustrates one embodiment of a hub node for use in an inventory transport monitoring system.

FIG. 4 illustrates an exemplary store floor plan depicting components of one embodiment of an inventory transport monitoring system for tracking inventory transports within a store.

FIG. 5 illustrates an exemplary screen shot of a tracking device depicting a path of movement of an inventory transport overlaid on a store floor plan.

FIG. 6 illustrates examples of inventory transports including a shopping cart, stocking cart, and a shopping basket.

FIG. 7 illustrates a quadrant based hub configuration for one embodiment of an inventory transport monitoring system.

FIG. 8 illustrates an example retail store floor plan showing positioning of various components in one embodiment of an inventory transport monitoring system.

FIG. 9 illustrates an example store floor plan showing hub zones of a multi-level store to accommodate tracking inventory transports at this retail location;

FIG. 10 illustrates a network topology example for one embodiment of the inventory transport monitoring system.

FIG. 11 illustrates setup and execution flow diagrams for an embodiment of a tracking node in the FIG. 10 inventory transport monitoring system.

FIG. 12 illustrates setup and execution flow diagrams for another embodiment of a tracking node in the FIG. 10 inventory transport monitoring system.

FIG. 13 illustrates setup and execution flow diagrams for an embodiment of a hub node in the FIG. 10 inventory transport monitoring system.

FIG. 14 illustrates another network topology example for an embodiment of the inventory transport monitoring system.

FIG. 15 illustrates setup and execution flow diagrams for an embodiment of a tracking node in the FIG. 14 inventory transport monitoring system.

FIG. 16 illustrates setup and execution flow diagrams for an embodiment of a hub node in the FIG. 14 inventory transport monitoring system.

FIG. 17 illustrates setup and execution flow diagrams for an embodiment of a coordinator node in the FIG. 14 inventory transport monitoring system.

FIG. 18 illustrates another network topology example for an embodiment of the inventory transport monitoring system.

FIG. 19 illustrates another network topology example for an embodiment of the inventory transport monitoring system.

FIG. 20 illustrates another network topology example for an embodiment of the inventory transport monitoring system.

FIG. 21 illustrates setup and execution flow diagrams for an embodiment of a coordinator node in the FIG. 20 inventory transport monitoring system.

FIG. 22 illustrates a state diagram for a tracking node in an embodiment of an inventory transport monitoring system.

FIG. 23 illustrates a state diagram for a hub node in an embodiment of an inventory transport monitoring system.

FIG. 24 illustrates a state diagram for a user device in an embodiment of an inventory transport monitoring system.

FIG. 25 illustrates a screen shot of a user device from an embodiment of the inventory transport monitoring system depicting inventory transport status.

FIG. 26 illustrates a screen shot of a user device from an embodiment of the inventory transport monitoring system depicting a heat map of customer travel, stop time, and specials traffic.

FIG. 27 illustrates a screen shot of a user device depicting an exemplary store list screen for a mobile device application.

FIG. 28 illustrates a screen shot of a user device depicting an exemplary store selection comparison screen for the mobile device application;

FIG. 29 illustrates a screen shot of a user device depicting an exemplary store selection comparison screen for the mobile device application;

FIG. 30 illustrates a screen shot of a user device depicting an exemplary store information screen for a mobile device application.

FIG. 31 illustrates a screen shot of a user device depicting an exemplary store information screen for a mobile device application.

FIG. 32 illustrates a screen shot of a user device depicting an exemplary cart list screen for the mobile device application.

FIG. 33 illustrates a screen shot of a user device depicting an exemplary cart list and filters screen for the mobile device application.

FIG. 34 illustrates a screen shot of a user device depicting an exemplary information screen for a mobile device application.

FIG. 35 illustrates a screen shot of a user device depicting an exemplary screen shot of a user device.

FIG. 36 illustrates a screen shot of a user device depicting an exemplary store list and cart notifications screen for the mobile device application.

FIG. 37 illustrates a system for transportation method of sealed, watertight, wireless charged nodes that read a fixed RFID.

FIG. 38 illustrates a screen shot of a user device depicting a store layout and asset information.

FIG. 39 illustrates a screen shot of a user device depicting an expanded view of asset information available by selecting a location or icon.

FIG. 40 illustrates a block diagram of one embodiment of an inventory transport monitoring system that includes various additional assets.

FIG. 41 shows a sensor used to track when inventory has been depleted. It can be configured and calibrated to only transmit signals when this empty condition has been met.

FIG. 42 shows a flowchart depicting one embodiment of determining the zone of a plurality of inventory transports.

FIG. 43A shows a table of representative data for multiple hubs.

FIG. 43B shows a representative data for an exemplary coordinator.

FIG. 44 shows a representative store layout with representative hub and zone locations.

### DESCRIPTION OF THE CURRENT EMBODIMENT

Before the current embodiment of the invention is described, it is pointed out that the invention is not limited to the details of operation, the details of construction, or the arrangement of the components set forth in the following description or illustrated in the drawings. The invention may be implemented in various other embodiments and may be practiced or carried out in alternative ways not expressly disclosed herein. Also, it is pointed out that the terminology used herein is for the purpose of description and should not be regarded as limiting. The use of “including” and “comprising” and variations thereof encompasses the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

Inventory Transport Monitoring System

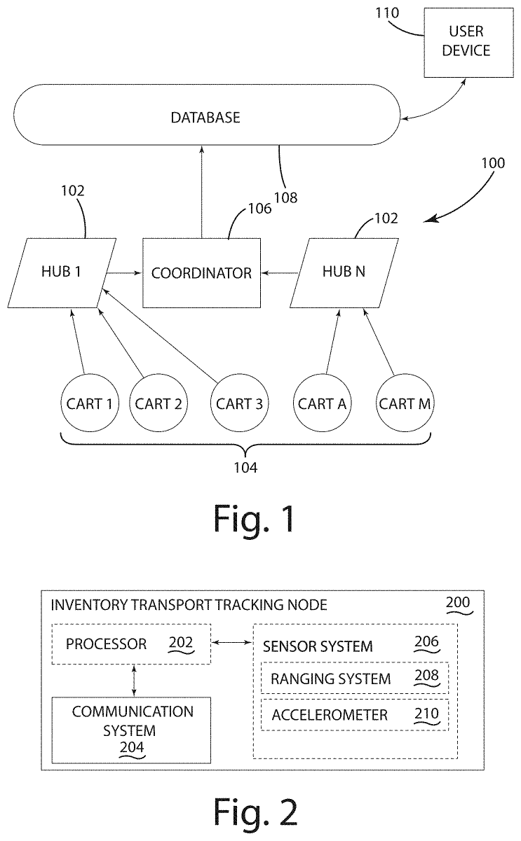

One embodiment of an inventory transport monitoring system 100 is illustrated in the block diagram of FIG. 1. The system includes hub nodes 102 positioned throughout a store, inventory transports 104 for moving inventory within the store each having a tracking node, a coordinator node 106 for receiving tracking information regarding the inventory transports, a database 108 for storing the information, and a user device 110 for conveying information to a user. The tracking nodes, in conjunction with the hub nodes, can be used to obtain information about the inventory transports as they travel around the store.

An inventory transport monitoring system can enable the collection of various characteristics and metrics. For example, characteristics can be collected about the positioning of the inventory transports over time or about the amount of time since each of the transports were last moved. These characteristics and metrics can be aggregated to characterize the store.

Referring to FIG. 1, an inventory transport monitoring system for gathering inventory transport usage information in a retail store, according to one embodiment of the present invention, includes a network of nodes, both tracking nodes and hub nodes, located within a retail store. The nodes can include various sensors and communication systems.

Various types of inventory transports such as inventory stocking carts, shopping carts, shopping baskets, or other inventory transports can have tracking nodes and be utilized throughout the store. FIG. 6 shows three exemplary inventory transports, each having an inventory transport tracking node affixed thereto.

An example of a retail store layout utilizing the inventory transport monitoring system is illustrated in FIG. 4. In this example, the store floor plan includes multiple hub nodes 102 positioned throughout the store. The inventory transports 104 are outfitted with nodes for tracking them within the store. As depicted, some nodes are affixed to stocking carts parked in the stock room and others are affixed to one or more shopping carts and baskets toward the front of the store. One node attached to a stocking cart is shown traveling just outside of the stocking area. The inventory transport monitoring system includes a ranging system such that the precise distance to each hub can be determined. In the depicted embodiment, the tracking node on the floor is about 77.5 feet to the café hub, 37.8 feet to the produce hub, and 22.2 feet to the stockroom hub. In the depicted embodiment, the stockroom hub is configured as a coordinator that handles telematics to a remote database. Alternatively, a separate coordinator that handles the telematics may communicate with one or more of the hubs.

The tracking nodes 200 interact with hubs 102 positioned around the store in order to generate information about the movement and position of the transports. Depending on the communication system and sensors included in the tracking node, different information can be obtained. For example, in some embodiments, acceleration data, ranging data, position data, proximity data, use data, and pattern data, can all be collected. In the depicted embodiment, each tracking node has a unique ID that is broadcast periodically in a packet of information that includes sensor information measured at that tracking node, such as acceleration information. Other information can be discerned by the strength or other characteristic of the communication signal between the hub node 102 and the tracking node 200. The information can be broadcast using essentially any wireless protocol such as WiFi, Zigbee, or BLTE. In the current embodiment, the hub nodes listen for signals being broadcast by tracking nodes 200 traveling around the store. The received information can be used to understand a variety of information about the tracking node and the inventory transport to which it is attached. For example, the information can be used to determine where the node 200 has been moved and in what pattern. The information can be communicated through the network of hub nodes 102 and tracking nodes 200 to reach the coordinator 106 where it can be relayed to a database for storage and analysis.

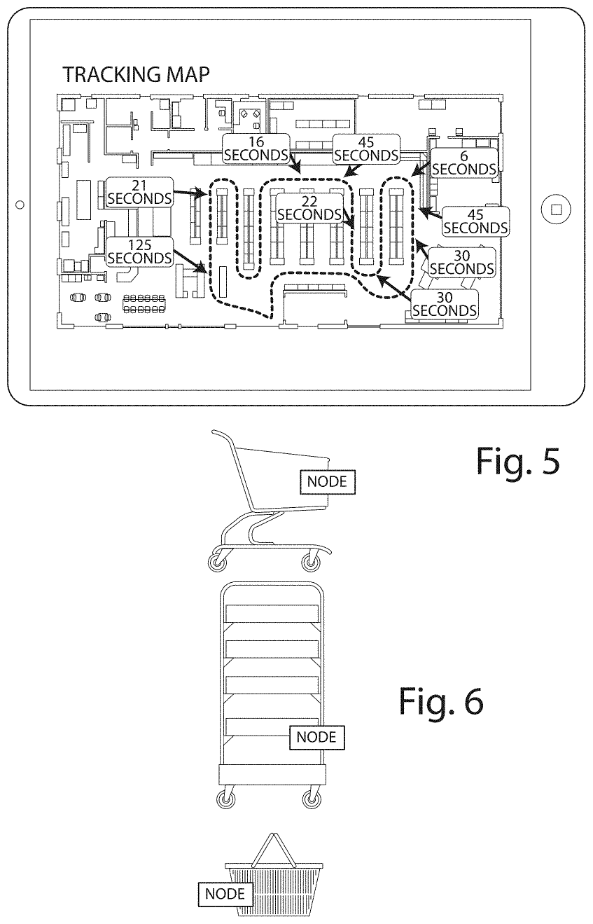

The system can be used to track information about an inventory stocking cart within the retail store. Examples of the type of information that can be tracked include location information, pathing information, and timing information. In one embodiment, the node on the inventory stocking cart can communicate with the various hubs around the store and that information, both the substance of the communication and the timing of the communication, can be used to track various information about the inventory stocking cart such as the path of the inventory stocking cart, the number of stops the cart made, and how long the cart stopped at each location. An example of such inventory stocking cart activity can be seen in FIG. 5. In this example, the inventory stocking cart was loaded with inventory to be stocked on the store shelves. The route that the inventory cart took through the store during the stocking event can be transmitted to the store hub. Over time, the stocking information can be used to identify habits and best practices.

The system can use the usage information collected from the individual stores to measure and compare successful stores to failing or struggling stores in an attempt to determine which inventory cycle metrics are critical to success. A successful store can be determined based on its profitability, or other determining factors. Thus, the system can collect usage information from a successful store in an attempt to identify what characteristics or inventory performance factors contribute to the store's success. Once identified, these characteristics or inventory performance factors can be implemented at less successful stores.

The system can track the time and location at which the inventory stocking cart is moved, this information can be useful as a metric for tracking the time that employees spend doing various tasks within the store. Understanding the timing of certain tasks and the time to perform these tasks can be helpful in increasing a store's profitability. By better understanding standard times as they relate to other aspects of the business like customer flow, volume of sales, traffic patterns a better understanding of labor requirements and efficiencies can be analyzed. The system can track the time spent, the direction, and the location of the inventory stocking carts within the store floor plan. Some inventory may be deemed priority, and may be delivered to the retail floor on a priority basis. Store aisle information and optimum timing based on business cycles and profitability of product to be shelved may also be considered. Consumer consumption/purchase information and product profitability can be used to prioritize restocking timing

Inventory Transport Tracking Node

An exemplary inventory transport tracking node 200 is illustrated in the block diagram of FIG. 2. The tracking node 200 includes a communication system 204, and in some embodiments optionally includes either or both of a processor 202, and a sensor system 206 with one or more different types of sensors. In some embodiments, the tracking node can include additional circuitry such as a battery, lighting, a speaker, or essentially any other circuitry.

Each tracking node 200 can be used in connection with inventory carts, shopping carts, baskets, and any other type of inventory transport. Each tracking node can be physically joined to and associated with an inventory transport, for example by affixing it to an inventory transport or being integrated with a component of the inventory transport. The tracking node 200 can enable tracking a variety of characteristics and metrics about the inventory transport to which it is associated. For example, the strength of a communication signal between a tracking node 200 and one or more hub nodes 102 can be used to determine the position or movement of the tracking node, and therefore the inventory transport. Further, the timing of the communication signals between the tracking node 200 and the one or more hub nodes 102 can be used to determine other information about the inventory transport, for example the path of movement of the inventory transport or the amount of time since the inventory transport was last moved. This information, when aggregated with similar information from different inventory transport tracking nodes across many different stores, can be helpful in identifying characteristics of a successful or efficient store that can be copied in less successful or inefficient stores, or identifying characteristics of less successful or inefficient stores that can be changed and avoided in the future.

The optional sensor system 206 on the inventory transport tracking node can include one or more different sensors. For example, the sensor system 206 can include a ranging system 208, which can determine distance to a hub node that also has a ranging system component, or an accelerometer 210, which can measure acceleration of the inventory cart.

Although some embodiments of the inventory transport tracking node include a processor 202, some do not. In some embodiments, the inventory transport tracking node does not process information. For example, the inventory transport tracking node may periodically transmit a beacon signal. The beacon signal can be configured to have a particular strength, which the hub nodes positioned around the store can listen for and hear. In this example, the inventory transport tracking node does not include any sensors or processors, but instead provides information to the hub nodes by way of the ID of the tracking node, strength of the communication signal, and timing of the communication signal being received. The same power savings used in the periodical transmission can be used for the sensors determining if movement or sensor data has changed since the last waking period. This can be helpful to determine if the cart is moving and for how long. An example would be if the beacon transmits every 10 seconds and the cart moves for 1.2 minutes we could see 10-12 signals indicating movement. The inventory transport tracking node may or may not have additional supporting circuitry. For example, the communication system may be powered by a battery in the tracking node, or alternatively the inventory transport system may provide a wireless power signal to power the tracking node. In another exemplary inventory transport tracking node, a processor that buffers, stores, or processes information is included on the tracking node. For example, the processor may be capable of processing signals received or measured by the tracking node and recognizing patterns, events, or activities such that instead of or in addition to raw data being communicated to the hub nodes or coordinator, processed information about a recognized pattern, event, or activity can be communicated. The processor may include internal or external memory. In addition, memory may be included on the tracking node regardless of whether a processor is included. For example, any of the sensor system components may include internal or external memory.

FIG. 22 illustrates an exemplary state diagram for one embodiment of a tracking node. In a sleep state, the tracking node accumulates sleep time using the real time clock 2202. This information can be stored in memory on the tracking node and later uploaded to a database. In this embodiment, power to an accelerometer is maintained or periodically provided while other circuitry is in the sleep mode. If movement is detected, or in other embodiments if a predetermined amount of time passes, a timer is started and RFID is read 2204. RFID can refer to the identification of the cart the device in on. The tracking node is configured to record tracking information, such as movement time, ID, and other sensor data and events 2206. The tracking node also attempts to communicate with one or more hub nodes, for example any BLTE hub beacon nodes in proximity 2208. The tracking node or another component within the system may include a processor that can recognize patterns and log events. Information can be conditionally sent to a hub node and/or a coordinator node 2210. The firmware of the node can be checked and updated 2212. The BLTE mobile interface and beacon can be checked if enabled 2214. Examples include calibration modes, set up configurations and other modes that can provided, when available a mobile device can communicate two ways with the cart/beacon. This allows additional data to be monitored or set-up details to be configured. If movement has stopped, for example by the accelerometer measurement going below a predetermined threshold for a threshold amount of time, the node can be put back into a sleep state awaiting interruption from the accelerometer detecting movement 2216.

Inventory Transport Hub Nodes

Hub nodes can be located in the retail store to track metrics in real time to better understand distribution of the inventory transports and inventory cycles. This usage information can be utilized to help coach the store managers to better manage the store and keep inventory levels at an optimum level. The system can also create a metric for the retail store's corporate office to evaluate differences between the different retail stores, such as the best and worst performing stores. Metrics can be defined to track various aspects of distribution of goods in a retail store.

Hub nodes can work in conjunction with the inventory transport tracking nodes to obtain information about the inventory transports in the store. The hub node can include a variety of different components. A hub node includes a communication system for communicating with tracking nodes on inventory transports. In some embodiments, the hub nodes relay information collected from the tracking nodes to a coordinator. The same or a different communication system can be used to conduct the relaying. Alternatively, or in addition, the tracking nodes themselves may communicate directly to a coordinator.

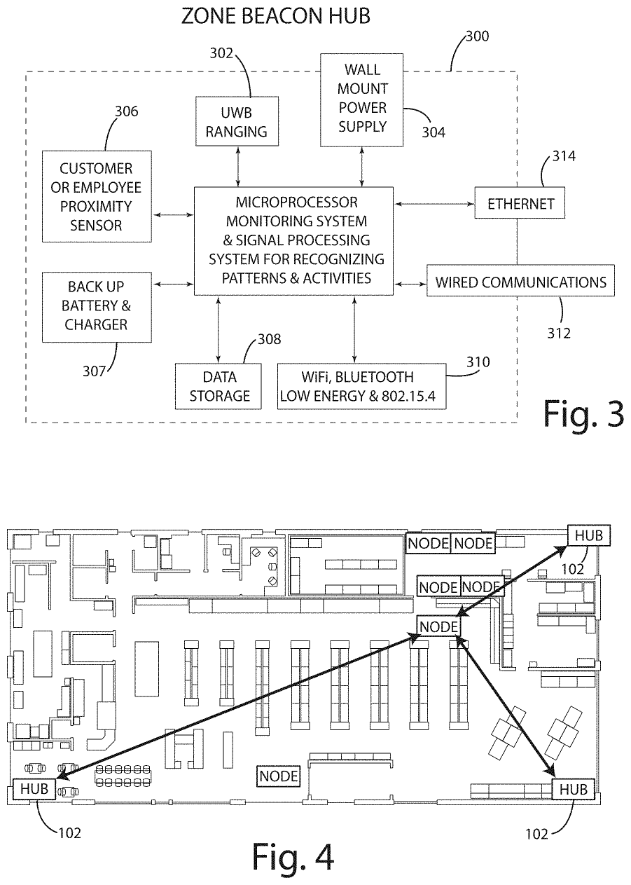

One embodiment of a hub node is illustrated in the block diagram of FIG. 3. As depicted, the hub node can include a UWB ranging system 302, a wall mount power supply 304, a customer or employee proximity sensor 306, a back-up battery and charger 307, memory 308, a communication system 310, a wired communication system 312, an Ethernet connection 314, and a processor 316. The hub 300 of the depicted embodiment includes a communication system 304 capable of communicating via Wi-Fi, BTLE, or Zigbee. In alternative embodiments, the hub communication system may be capable of communicating through additional, fewer, or different protocols.

The FIG. 3 hub embodiment includes an ultra-wide band ranging module that enables precise distance measurements that can be used to precisely locate tracking nodes within a store space.

Some stores include walls and floors with steel reinforcements or interference that can make wireless communication difficult. Accordingly, some hubs may include physical connections to reach areas that may be difficult to reach through wireless communication due to shielding or interference.

The hub may include a proximity sensor for employee and customer data. This can be used to monitor customer flow, need for checkout assistance, or to determine whether a service person or cashier is present, or other information.

The components of the depicted hub 300 include a microprocessor monitoring system and signal processing system for recognizing patterns and activities. This processor can process tracking information received from tracking devices into different types of tracking data. For example, a hub, or a collection of hubs networked together working in tandem, can determine a path of an inventory transport by monitoring the changes in in signal strength of a tracking device over time. In alternative embodiments, the hub may not include such processing capability and instead may relay the raw tracking data upstream for processing elsewhere in the system. The zone hub may also partially process the data and pass the partially processed data upstream for further processing elsewhere in the system.

The hub node illustrated in FIG. 3 is a zone beacon hub node. It is referred to as a “zone” hub node because it is permanently installed in the store, associated with and monitors a physical area or zone of the store. That is, each zone hub node defines a particular room, section, quadrant, or area so that the system can differentiate between inventory storage and retail segments of floor space within a store. In alternative embodiments, some or all of the hub nodes can be a different type than a “zone” hub.

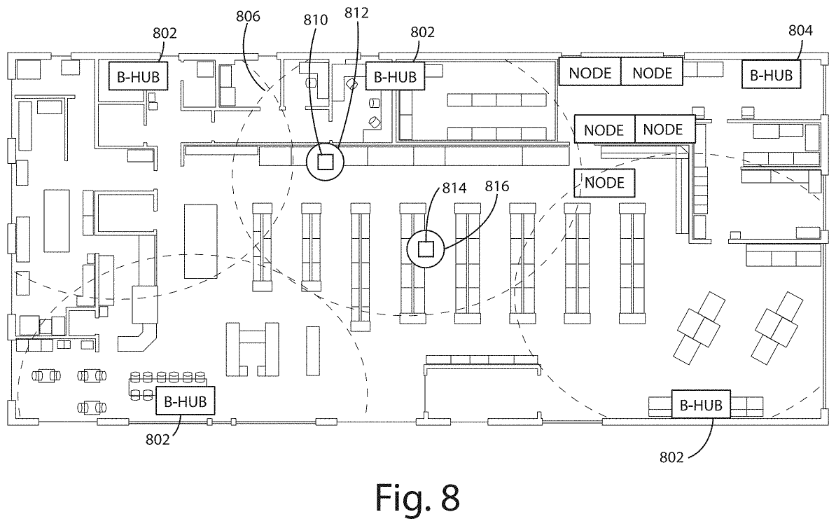

Additional hub nodes can be placed within a hub node zone to create sub-zones. For example, in FIG. 8, two hub nodes 810 and 814 are positioned inside of a hub zone 806. These two hub nodes 810 and 814 create, respectively, two sub-zones 812, 816. The sub-zones can be useful for obtaining additional information about a particular area of the store. For example, subzone 812 is positioned near a few shelves in the frozen food aisle and subzone 816 is positioned near a particular shelf in one of the aisles. The hub nodes that create sub-zones need not be, but may, be different than a hub node that defines a zone. In some embodiments, for example where the subzone is generally a small area, the hub node may be run on a battery and periodically power up and transmit/listen for a predefined amount of time before sleeping for a predefined amount of time. In this way, battery life can be preserved. If the broadcast signal or listening range is weak because the subzone is small (perhaps a few feet radius), it may be capable of being powered by a battery for 20 or more years, avoiding or the issue of having to replace batteries in the hub nodes around the store too often. Further, providing a smaller subzone can provide additional granularity in the data collected.

The FIG. 3 hub node can also be referred to as a “beacon” hub node because it periodically transmits a communication signal or beacon, which tracking nodes can listen for and can respond to in order to generate tracking information. Alternative types of hub nodes can reverse this, for example, a “listening” hub may instead listen for beacon signals transmit from tracking nodes in order to generate tracking data.

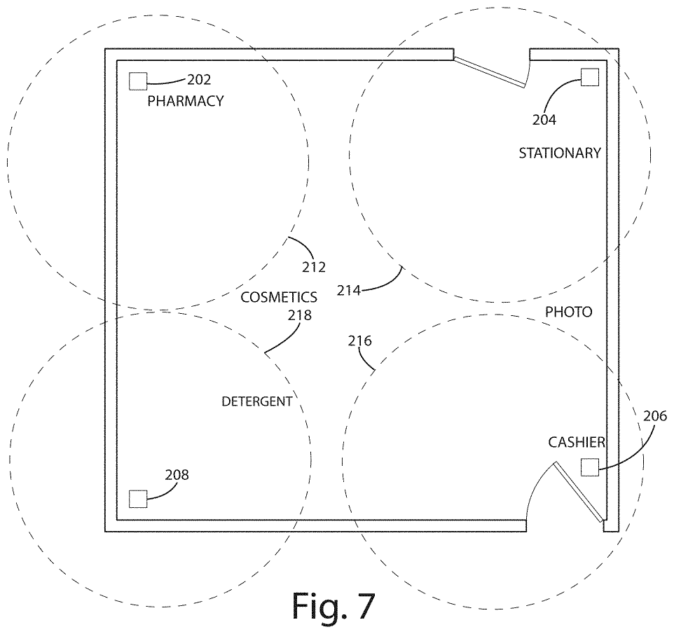

An example floor diagram of zone hub nodes set up within in a retail store is shown in FIG. 7. In the depicted embodiment, four zone hub nodes 202, 204, 206, 208 are installed in various positions within the store. Each of these hubs has an associated zone 212, 214, 216, 218 that defines an approximate area associated with that hub. A node within one of the zones can be tracked as being in proximity to the associated hub. The zone may represent an approximate transmit or receive range of the hub. Alternatively, the zone may be unrelated to the transmit or receive range of the hub, but rather may represent a physical space near a particular hub. For example, hubs may receive broadcast signals from tracking nodes outside of their respective nodes, and the strength of the signal determines whether the tracking node is in proximity to the hub node, and therefore within the associated zone hub. The number and placement of the hubs, and the corresponding zones, can be positioned to define zones that relate to departments within a retail environment, for example, pharmacy, cosmetics, detergent, stationary, photo, and cashier departments.

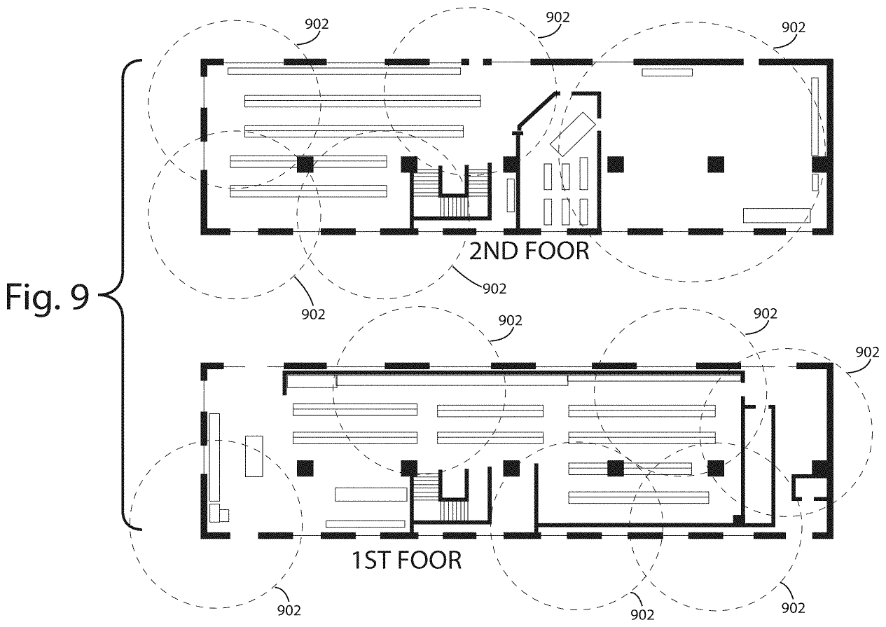

FIG. 8 shows another example floor diagram. The depicted floor plan includes five zone beacon hubs. Four of the hub nodes 802 are located throughout the main store area, and one of the hub nodes 804 is located in the stockroom. The stockroom hub node 804 is wired to one of the hub nodes 802 in the main area because the hub nodes cannot reliably communicate through the stock room walls. As tracking nodes move through the store periodically broadcasting their IDs, the tracking nodes can be associated with the appropriate zone in proximity In this embodiment, nodes within the boundary areas can be tracked by signal levels and as the signal levels change, the position of the tracking node can be tracked to different zones. This effectively allows the ID to be advertised at an interval and allows the zone hubs to coordinate the locational information, timing, and change of position over time. FIG. 9 shows another example of a floor diagram with an inventory transport monitoring system. In this example configuration a multi-level store has hub nodes installed throughout the store that provide the illustrated zones 902. In this embodiment, the hub nodes communicate via Bluetooth to accommodate tracking the inventory transports.

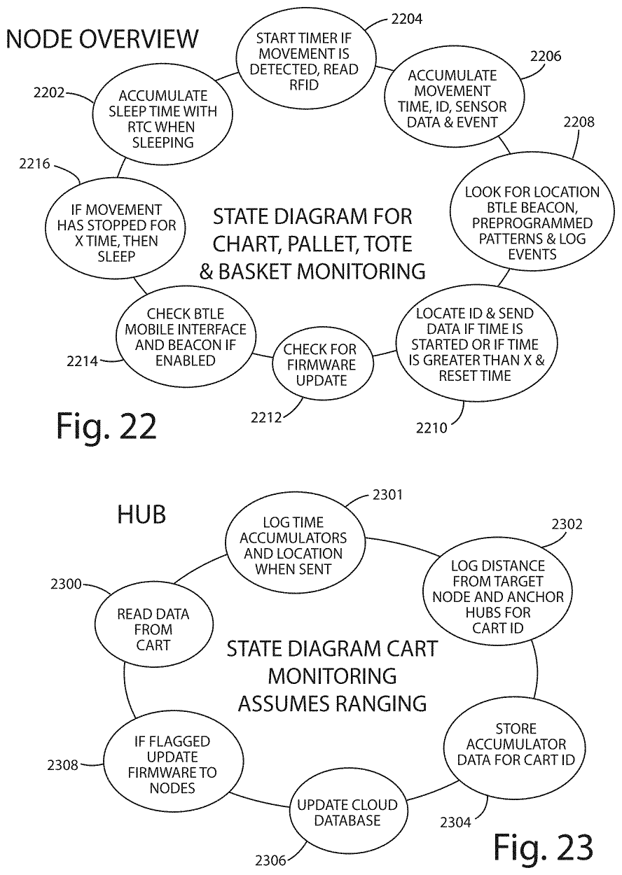

An exemplary state diagram for one embodiment of a hub node with a ranging feature is illustrated in FIG. 23. In this embodiment, the hub node receives signals from tracking nodes affixed to a stocking cart 2300. The hub node can log the information from the tracking node signal, such as any time accumulator information and location information 2301. The hub node can log distance from the target tracking node utilizing ranging system data from the tracking node and other hub nodes 2302. Other information about the tracking node can be stored associated with the node ID 2304. The data can be periodically or in response to a predetermined condition be uploaded to a local or cloud database 2306. Firmware can be downloaded and distributed to any of the nodes in the system 2308, then the hub can continue to listen for additional tracking node signals.

Network Topology

The nodes can be configured according to a variety of different network topologies. The network topology is the pattern in which nodes (i.e., hub nodes, tracking nodes, coordinators, or other devices) are connected. In some embodiments, there are multiple network topologies involved in the system.

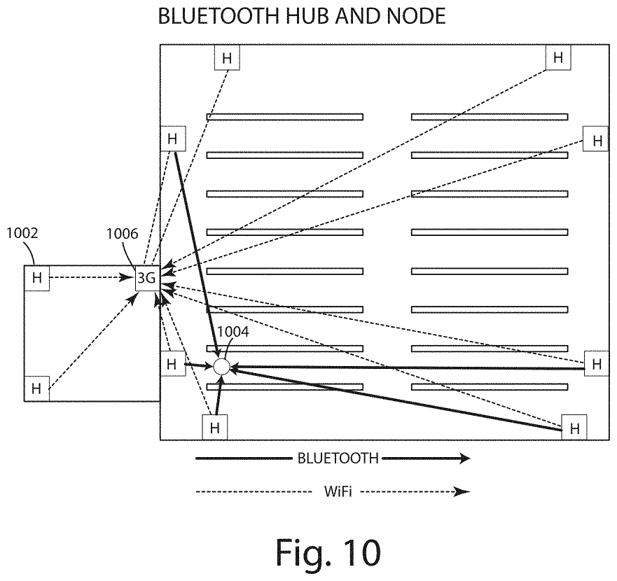

FIG. 10 shows one example topology where hub nodes 1002 communicate with tracking nodes 1004 via Bluetooth, hub nodes 1004 communicate with a coordinator 1006 via WiFi, and the coordinator communicates externally (i.e., to a database) via a 3G connection. The Bluetooth network is used to gather information from tracking nodes as they traverse the store space. The Wifi network is used to gather the information from all the hubs and the 3G coordinator pushes that information up to the cloud. Based on a strength signal, for example Received Signal Strength Indicator (RSSI), a tracking node can be assigned to a zone based on proximity to one or more hubs. Alternative communications can be used between hubs like Ethernet, Zigbee, and connected solutions for through barriers.

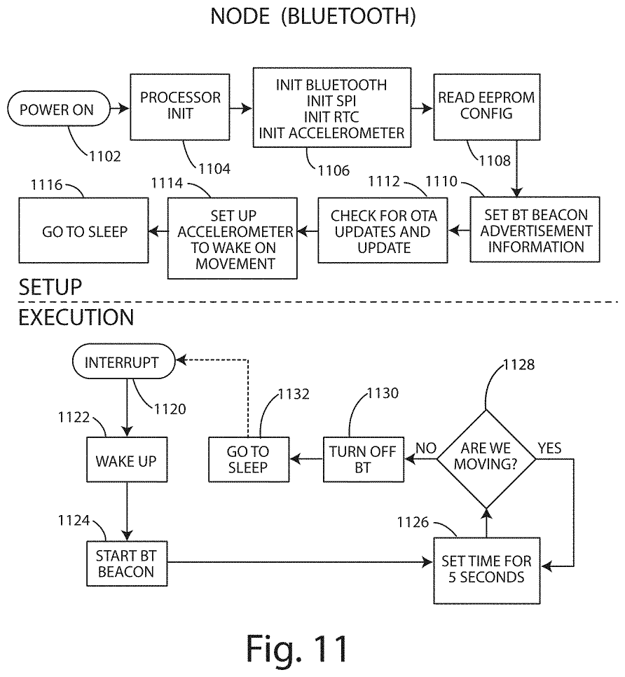

FIG. 11 illustrates exemplary embodiments of setup and execution flowcharts for a tracking node. The setup flowchart shows the process of configuring a tracking node for use within an inventory transport monitoring system. The process includes powering on the tracking node 1102, waiting for the processor to initialize 1104, waiting for the Bluetooth, serial peripheral interface (SPI), real time clock (RTC), and accelerometer to initialize 1106, reading the EEPROM configuration 1108, setting the Bluetooth beacon advertisement information 1110, checking for Over-the-Air updates and updating the tracking node if any are available 1112, setting up the accelerometer to wake up the other circuitry upon detection of movement over a predetermined threshold 1114, placing the node in sleep mode 1116.

The execution flowchart illustrates the normal operation of the exemplary tracking node in an inventory transport monitoring system. In response to an interrupt (for example, movement over a predetermined threshold detected by an accelerometer) 1120 the sleeping circuitry is powered up 1122. After being powered up, the Bluetooth beacon signal begins transmission 1124, the beacon is transmitted for an amount of time (in this example 5 seconds) 1126 after which the accelerometer is consulted to determine whether the node is still moving 1128. If the node is still moving, then the Bluetooth signal continues to be broadcast another 5 seconds 1126, if the node is no longer moving (for example, below a threshold value measured on the accelerometer), then the Bluetooth broadcast is turned off 1130, and the node circuitry except for the circuitry for detecting the interrupt goes back to sleep 1132.

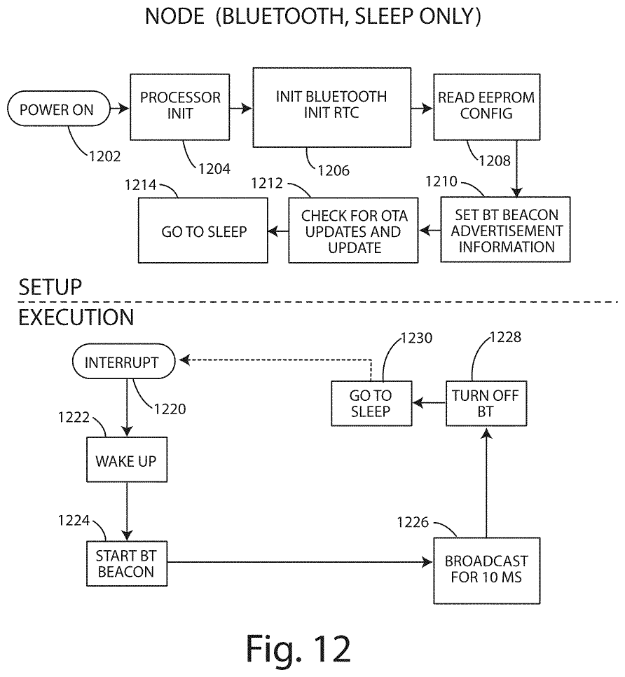

FIG. 12 illustrates additional exemplary embodiment of setup and execution flowcharts for a tracking node. These flowcharts are for a tracking node that only utilizes a Bluetooth communication system and does not include any peripherals or other sensors such as an accelerometer. The only difference between the FIG. 11 setup flowchart and the FIG. 12 setup flowchart is that there is no SPI initialization or accelerometer initialization, and there is no accelerometer setup because those components are not utilized in this configuration. The process depicted in FIG. 12 includes powering on the tracking node 1202, waiting for the processor to initialize 1204, waiting for the Bluetooth and real time clock (RTC) to initialize 1206, reading the EEPROM configuration 1208, setting the Bluetooth beacon advertisement information 1210, checking for Over-the-Air updates and updating the tracking node if any are available 1212, and placing the node in sleep mode 1214.

The execution flowchart of FIG. 12 illustrates the normal operation of the exemplary tracking node in an inventory transport monitoring system. Because the accelerometer is not used as an interrupt in this configuration, the node's sleep is interrupted by a timer 1220, in response to which it powers up 1222, starts the Bluetooth broadcast signal 1224, and continues to broadcast for a predetermined amount of time (in this example 10 ms) 1226, after which the Bluetooth broadcast is turned off 1228, and the node is configured to go back to sleep 1230 until the predetermined amount of time passes (for example 5 seconds) and the node is interrupted by the clock 1220. The interrupt time and the broadcast time can vary from application to application depending on a wide variety of factors. For example, the amount of time the node broadcasts and the amount of time the node sleeps before waking up to broadcast can both affect battery life of the node.

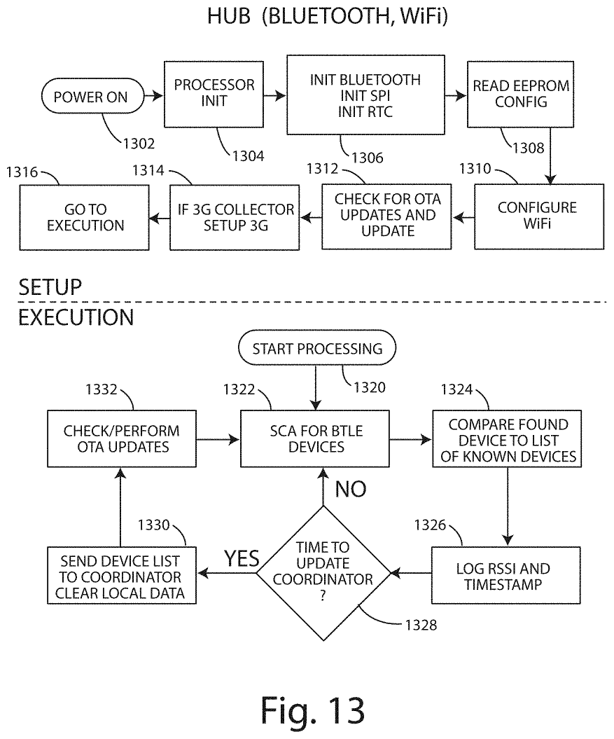

FIG. 13 illustrates exemplary embodiments of setup and execution flowcharts for a hub node. The setup flowchart shows the process of configuring a hub node for use within an inventory transport monitoring system. The process includes powering on the hub node 1302, waiting for the processor to initialize 1304, waiting for the Bluetooth, serial peripheral interface (SPI), and real time clock (RTC) to initialize 1306, reading the EEPROM configuration 1308, configuring the WiFi 1310, checking for Over-the-Air updates and updating the hub node if any are available 1312, if the hub is also a coordinator with 3G capability configuring the 3G settings 1314, and configuring the hub node for execution mode 1316.

The execution flowchart shows the execution process for a hub node in an inventory transport monitoring system. The process begins 1320 with a scan for BLTE devices 1322, if devices are found the IDs are compared to a list of known devices 1324, a log of RSSI and timestamp may be recorded 1326, a check is made of whether it is time to update the coordinator 1328. The timing can be based on a variety of factors, for example the time since the last update or the amount of data in the log. If it is time to update the coordinator a device list along with RSSI and timestamp information is sent to the coordinator and the local data can be cleared 1330. The hub node can check and, if available, perform any OTA updates for the hub node 1332. Once finished with that, or if it is not time to update the coordinator, the hub node continues to scan or listen for BLTE devices. It should be noted that all hubs may receive data from a given node and have signal strength data regarding that node. That corresponding data becomes more rich for determining actual locations.

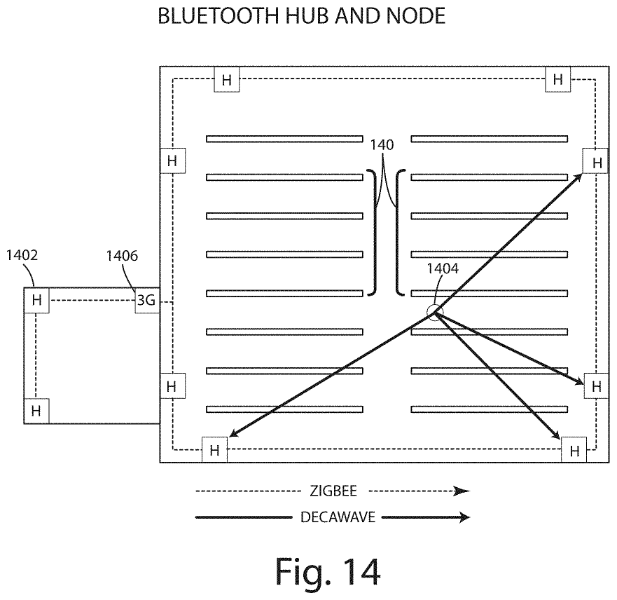

FIG. 14 shows another example topology. In this topology hub nodes 1402 communicate with tracking nodes 1404 via DecaWave, hub nodes 1404 communicate with each other and the coordinator 1406 via ZigBee, and the coordinator communicates externally (i.e., to a database) via a 3G connection. The DecaWave technology uses ultra-wide band ranging to gather distance information from tracking nodes as they traverse the store space. DecaWave uses time of flight over multiple frequencies to provide a relatively accurate position of the device through triangulation by time, event, or request. The DecaWave allows position to be triangulation based on distance from at least three hubs. Other information can also be communicated over the DecaWave protocol, such as sensor data. The ZigBee network is used to gather the information from all the hubs and the 3G coordinator pushes that information up to the cloud. Based on the DecaWave position information collected at the hubs, a tracking node can be assigned to different zones 1410 as it traverses the store space. As with other embodiments, alternative communication systems can be used between the nodes such as Ethernet, or other connected solutions for communication through interference or shielded regions.

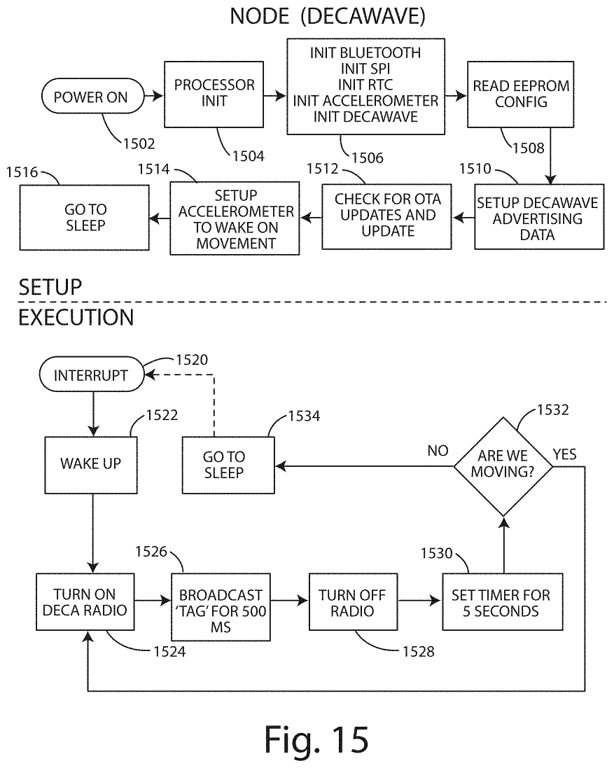

FIG. 15 illustrates exemplary embodiments of setup and execution flowcharts for a DecaWave tracking node. The DecaWave tracking nodes use alternative location technology based on triangulation and time of flight using ultra-wide band communications. The DecaWave nodes act much the way they do with the prior discussed BTLE hubs.

The setup flowchart shows the process of configuring a DecaWave tracking node for use within an inventory transport monitoring system. The process includes powering on the DecaWave node 1502, waiting for the processor to initialize 1504, waiting for the Bluetooth, serial peripheral interface (SPI), real time clock (RTC), accelerometer, and DecaWave circuitry to initialize 1506, reading the EEPROM configuration 1508, setting up the DecaWave advertising data information 1510, checking for Over-the-Air updates and updating the node if any are available 1512, setting up the accelerometer to wake up the other circuitry upon detection of movement over a predetermined threshold 1514, placing the node in sleep mode 1516.

The execution flowchart of FIG. 15 illustrates the normal operation of the exemplary DecaWave tracking node in an inventory transport monitoring system. In response to an interrupt (for example, movement over a predetermined threshold detected by an accelerometer) 1520 the sleeping circuitry is powered up 1522. After being powered up, the DecaWave radio is powered up 1524, the DecaWave broadcast is transmitted, which can include an ID, node type, calibration modes, and other information for 500 ms 1526, the DecaWave radio is turned off 1528, the node waits for a predetermined amount of time (5 seconds in this example) 1530, the node determines if it is moving (for example, movement over a predetermined threshold detected by an accelerometer) 1532, if it is, the DecaWave radio is turned on again, for example to broadcast location, mode and ID information 1524, if it is not then the circuitry is placed into a sleep mode 1534 where it awaits an interrupt 1520.

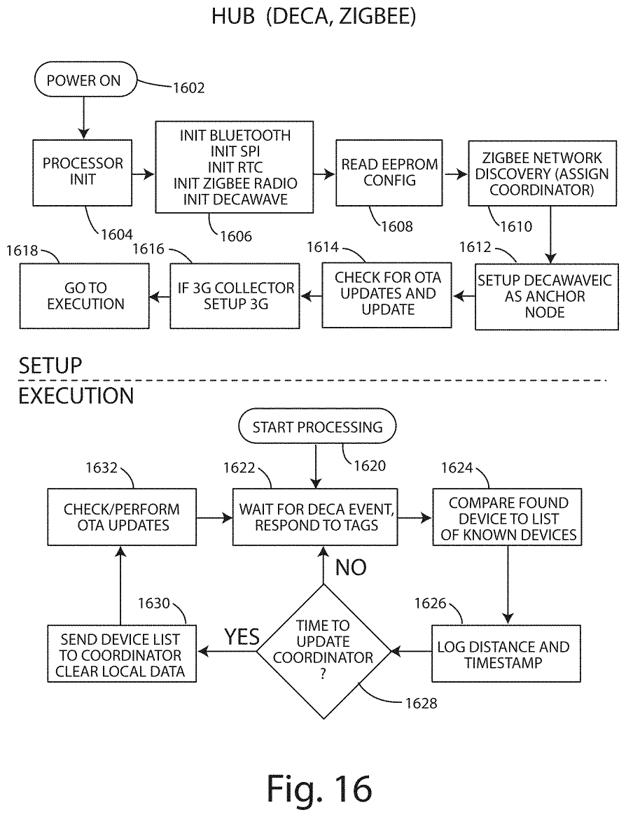

FIG. 16 illustrates exemplary embodiments of setup and execution flowcharts for a DecaWave hub node that utilizes triangulation. The setup flowchart shows the process of configuring a DecaWave hub node for use within an inventory transport monitoring system. The process includes powering on the DecaWave hub node 1602, waiting for the processor to initialize 1604, waiting for the Bluetooth, serial peripheral interface (SPI), real time clock (RTC), ZigBee radio, and DecaWave radio to initialize 1606, reading the EEPROM configuration 1608, iZigbee network discovery 1610 including if the hub is also a ZigBee coordinator configuring any ZigBee coordinator node settings, configuring the DecaWave circuit as an anchor or zone node 1612, checking for Over-the-Air updates and updating the hub node if any are available 1614, if the hub is also a coordinator with 3G capability configuring the 3G settings 1616, and configuring the DecaWave hub node for execution mode 1618. Configuration can be locating the anchors on a grid to identify distances or located with GPS or GPS like information relating to the installation.

The execution flowchart shows the execution process for a DecaWave hub node in an inventory transport monitoring system. The process begins 1320 with waiting for a Deca event and responding to tags 1622, if devices are found the IDs are compared to a list of known devices 1624, a log of distances and timestamps may be recorded 1626, a check is made of whether it is time to update the coordinator 1628, in this embodiment the coordinator is a ZigBee Coordinator. The timing can be based on a variety of factors, for example the time since the last update or the amount of data in the log. If it is time to update the coordinator a device list along with distance and timestamp information is sent to the coordinator and the local data can be cleared 1630. The hub node can check and, if available, perform any OTA updates for the hub node 1632. Once finished with that, or if it is not time to update the coordinator, the hub node continues to wait for Deca events 1622.

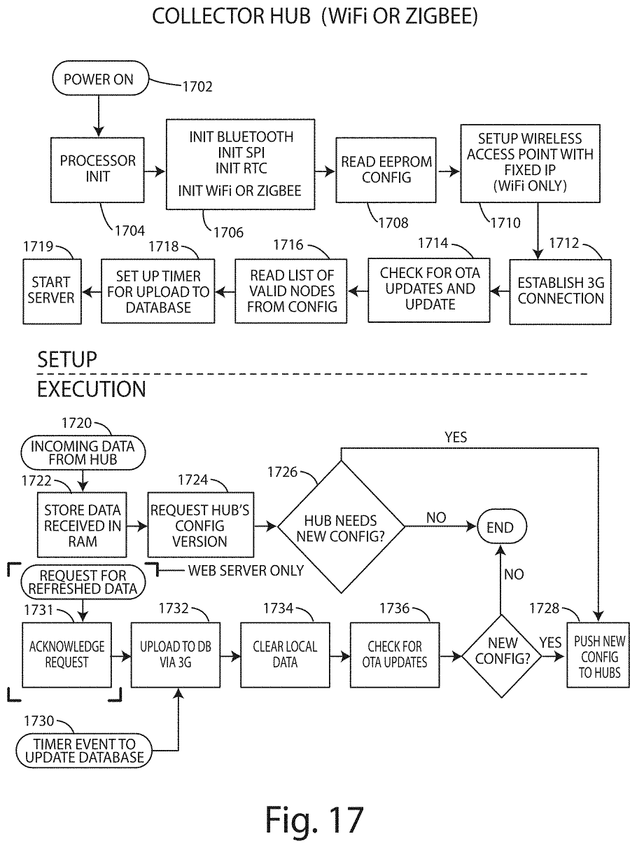

FIG. 17 shows the information collector hub (sometimes referred to as a coordinator or coordinator hub) setup and execution for gathering all the data and pushing it up to the cloud. FIG. 17 illustrates exemplary embodiments of setup and execution flowcharts for a collector or coordinator hub node. The setup flowchart shows the process of configuring a coordinator hub node for use within an inventory transport monitoring system. The process includes powering on the coordinator hub node 1702, waiting for the processor to initialize 1704, waiting for the Bluetooth, serial peripheral interface (SPI), real time clock (RTC), and ZigBee or WiFi radio to initialize 1706, reading the EEPROM configuration 1708, if utilizing WiFi setting up the wireless access point with a fixed IP 1710, establishing a 3G connection with a remote database 1712, checking for Over-the-Air updates and updating the hub node if any are available 1714, read list of valid nodes from config 1716, set up a timer for periodic uploads to the database via the 3G connection 1718, move to execution mode 1719.

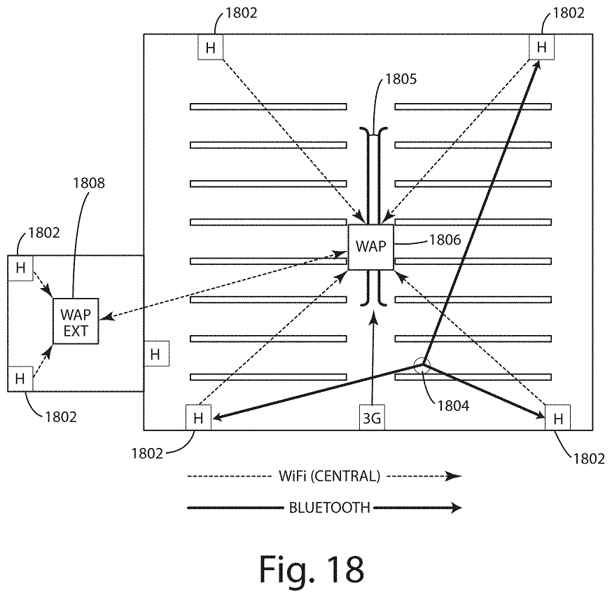

The FIG. 17 execution flowchart shows the normal execution state for the coordinator hub node for use within an inventory transport monitoring system. The process includes receiving data from other hub nodes 1720, storing that data in RAM or other local temporary storage 1722, requesting the hub's configuration version 1724, determining whether the hub needs a new configuration 1726, if yes pushing a new configuration to the hub node 1728, if no waiting for additional data from hub nodes 1720. A separate timer event also triggers to begin a database update process 1730, in response to the timer event or in response to a request from the database server; information stored locally is uploaded to the database via 3G 1732. The local data is deleted from memory 1734, a check for OTA updates is performed 1736 and executed if appropriate 1728, otherwise the coordinator continues to wait for a new timer event, a request for refreshed data, or additional data from a hub node. [000102] Yet another network topology is depicted in FIG. 18. In this configuration, hub nodes 1802 communicate with tracking nodes 1804 via Bluetooth. At any given time a tracking node 1804 can be assigned a zone 1805 based on proximity to one or more hubs 1802. The proximity to a hub can be determined by the signal strength of the Bluetooth communication from the tracking node to the hub, i.e., RSSI value. In this embodiment, the hub nodes 1802 can communicate via WiFi to a central wireless access point (WAP) 1806. To extend the range of the wireless access point, a wireless access point extender 1808 can be utilized as depicted in FIG. 18. The wireless access point can communicate with a 3G coordinator node 1808 for uploading data to an external database.

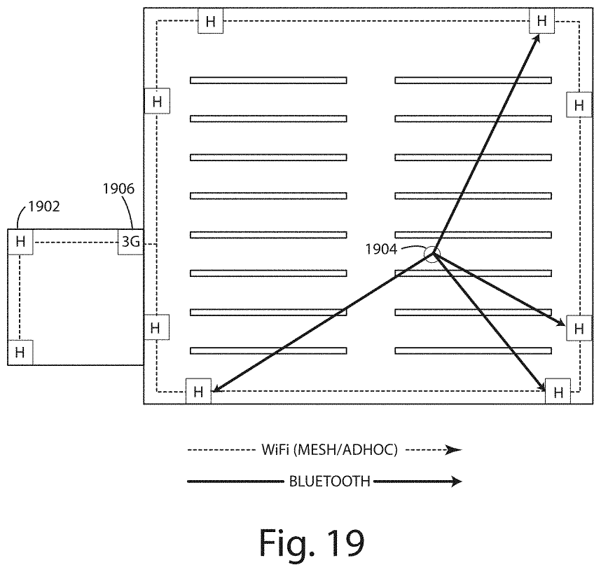

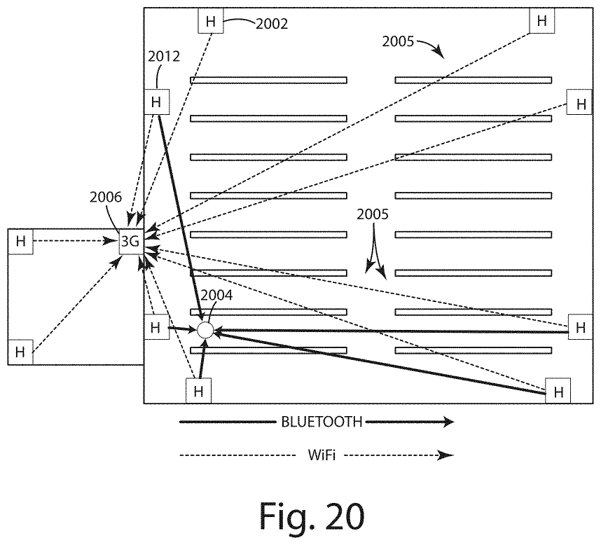

Another network topology is depicted in FIG. 19. In this configuration, hub nodes 1902 communicate with tracking nodes 1904 via Bluetooth. Just as in the FIG. 18 embodiment, nodes 1904 can be assigned a zone 1905 based on proximity to one or more hubs 1902. RSSI can be used to determine proximity In this topology, hubs 1902 and the coordinator 1906 communicate via WiFi Mesh/AdHoc mode. The coordinator 1906 communicates with a remote database server as in the previous embodiment, via 3G. [000104] FIG. 20 depicts an alternative embodiment where the 3G coordinator also acts as a wireless access point for the hubs to communicate via WiFi. As in some of the other embodiments, the hub nodes 2002 communicate with tracking nodes 2004 via Bluetooth. A tracking node 2004 can be assigned a zone 2005 based on proximity to one or more hubs 2002. The proximity to a hub can be determined by the signal strength of the Bluetooth communication from the tracking node to the hub, i.e., RSSI value. In this embodiment, the hub nodes 2002 can communicate via WiFi to the coordinator 2006, which is a central wireless access point (WAP) for communicating via WiFi to hub nodes and a 3G coordinator for communicating with a remote database.

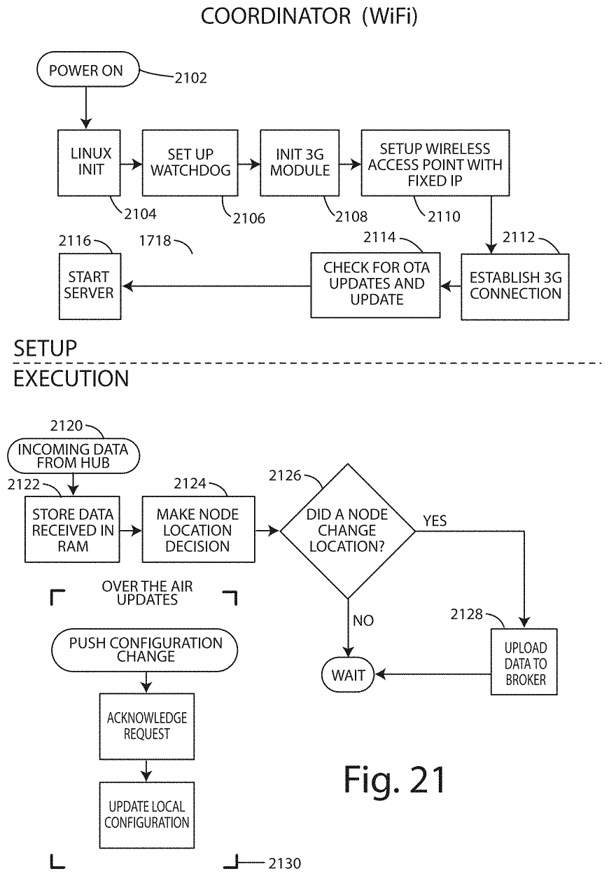

Exemplary embodiments of setup and execution flowcharts for a coordinator that is both a wireless access point and a 3G coordinator are illustrated in FIG. 21. The setup flowchart shows the process of configuring a coordinator for use within an inventory transport monitoring system. The process includes powering on the coordinator 2102, initializing the operating system (such as Linux) 2104, configuring watchdog 2106, initializing the 3G module 2108, configuring the wireless access point (for example with a fixed IP) 2110, establishing a 3G connection with a remote server 2112, checking for Over-the-Air updates and updating the coordinator if any are available 2114, and configuring the coordinator for execution mode 2116.

The execution flowchart shows the normal process for execution mode. The coordinator waits for incoming data from a hub node 2120, stores any received data in temporary memory 2122, such as RAM, determines the location of tracking nodes based on the received information 2124, determines whether any of the locations changed by comparing the determined locations to the previously stored locations for those tracking nodes 2126, if not, waiting for more information 2120, if yes, the data regarding the change in location is uploaded to the remote server for storage in a database 2128. The coordinator can check for over-the-air updates 2130.

User Device

The tracking information collected from the networked nodes in the inventory transport monitoring system can be analyzed and used to determine various characteristics and metrics that can be conveyed to a user on a user device. This can include real time data about the position and status of inventory transports, for example the user device can inform the user if an inventory cart has sat in the backroom without being pushed onto the floor of the store for too long, or if an inventory cart has been pushed to the store floor and the stocking is taking too long. Mash-ups of information can be conducted to determine correlations between the data obtained from the inventory transport monitoring system and other data sets. For example, data sets about inventory location in the stockroom, inventory delivery schedule, store profitability, stocking schedules, are a few examples of data sets that can be used in conjunction with the inventory transport monitoring data to provide information to a user on the user device. This information can be further aggregated to the store and/or region level.

The inventory transport monitoring system can include a variety of different types of user devices that provide various characteristics, metrics, and other information about the system to the user. The structure of the user device can vary depending on the application. Examples of user devices include a desktop computer or mobile device, such as a tablet or smart phone. The user device may include a processor, communication system for communicating directly or indirectly with the inventory transport monitoring system database, a display, and any other circuitry for conveying information to a user regarding the inventory transport monitoring system.

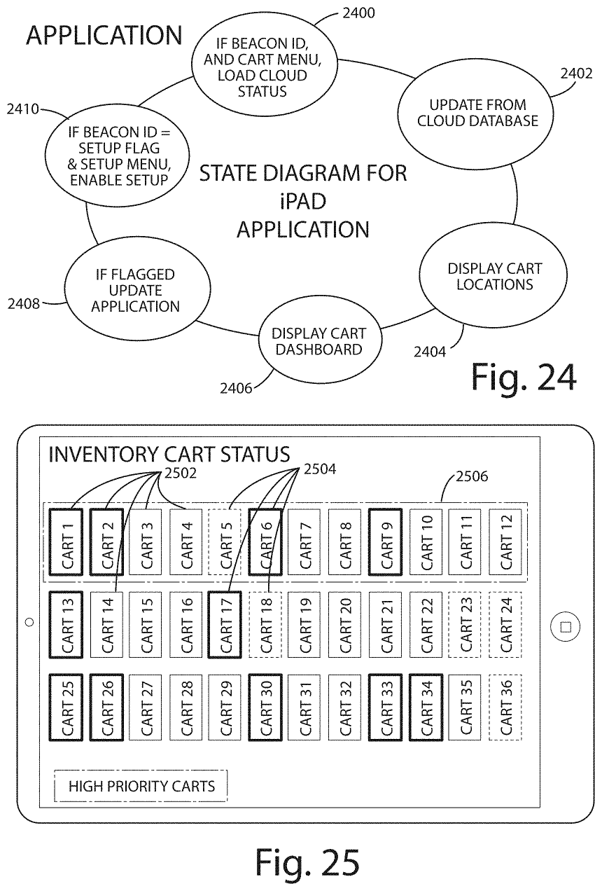

In use, the user device can communicate with the inventory transport monitoring system database to obtain information about the status and position of the inventory transports. FIG. 25 shows the inventory cart status based on optimal push times and profitability. The information of consumption and margin can be used to prioritize the timing against the labor cycle for that store according to an inventory restocking priority scheme. For example, inventory cart status can be displayed on a user device as illustrated in the screen shot of FIG. 25. In this embodiment, the carts are visually coded according to the time since they were last moved. This allows a store worker to quickly determine if inventory stocking carts are in good standing or not. For example, in the depicted embodiment each inventory transport is categorized as either “recently moved” 2502 or “not recently moved” 2504. This information can be helpful in order for a store worker to manage the movement of the stocking carts and ensure that stocking carts are being consistently pushed onto the floor for stocking. Additional information can be provided about the carts, for example statistics relating to the history of the cart and the type of inventory stored on a cart. Further, the carts can be further categorized with a priority level. For example, the first row of carts (carts 1-12) in the current embodiment are designated as higher priority 2506, which can be categorized according to a different set of criteria. For example, in the current embodiment, the high priority carts are coded as “not recently moved” if they have not been moved within 12 hours, whereas the other, normal priority carts, are coded “not recently moved” if they have not been moved within 24 hours. The specific conditions can be adjusted depending on the situation.

The use of stocking carts can vary over time depending on a variety of factors. Accordingly, some carts can be designated as buffer carts, season carts, or overstock carts, to name a few examples of cart labels. These labels can change how the status of the cart is presented on the user device. For example, the priority and therefore categorization of the carts can be affected by the label listed on the cart.

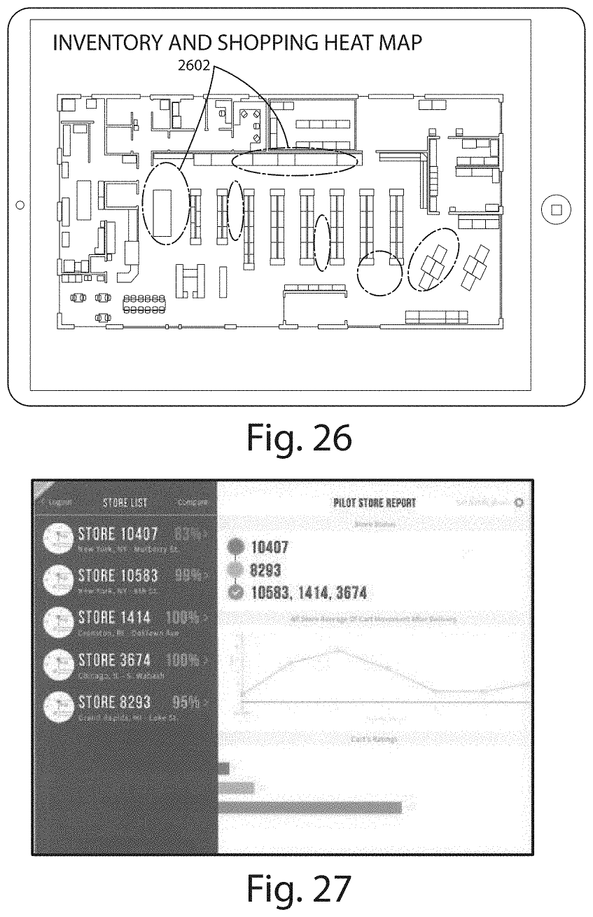

The inventory transport monitoring system can also provide information about shopping carts and shoppers in the store. For example, FIG. 26 illustrates a heat map of shoppers over a particular time frame in the store. This can be useful in determining what carts should be pushed because inventory may be low in heavily shopped areas 2602, but also what path should be used to push the stocking cart to avoid interrupting shoppers during a particular time frame.

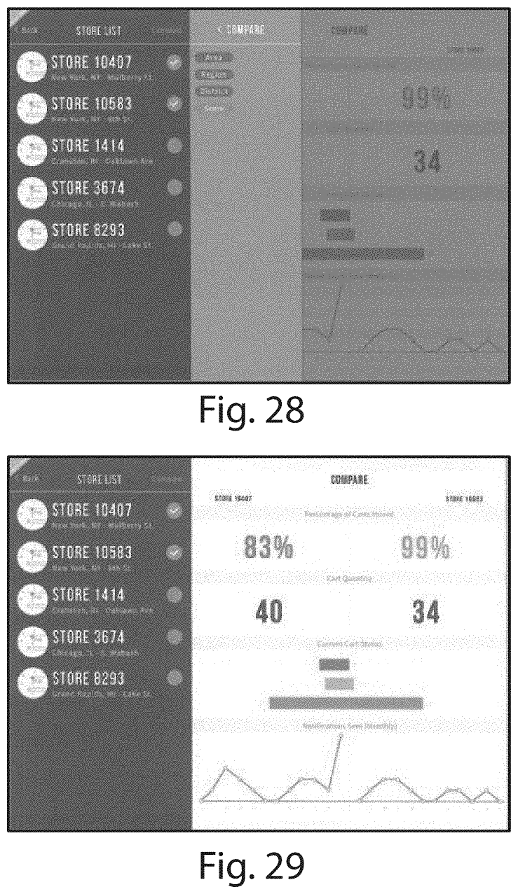

Another example of a user device is illustrated via the screen shots depicted in FIGS. 27-36. Collected tracking information can be analyzed, presented, and evaluated using a computer program or a smart device application. The exemplary screen shown in FIG. 27 illustrates a list of stores and store performance information comparing the number of days after delivery that the inventory, via the inventory stocking cart, is moved. The screens shown in FIGS. 28-29 illustrate a user selecting which store/area/region/district is desired for comparison, and then the comparison data of the selected stores. For example, store 10407 has 83% of its stocking carts moved, while store 10583 has 99% of its carts moved; store 10407 has 40 carts, while store 10583 has 34 carts. Further, the cart status of the two stores is compared: store 10407 has 7 carts with “red” status, 6 carts with “yellow” status, and 27 carts with “green” status; store 10583 has 0 carts with “red” status, 2 carts with “yellow” status, and 32 carts with “green” status. Additional information can be related to labor, employee locations and store traffic. Helping to understand the ideal times to stock, staff and utilize minimum staffing scenarios.

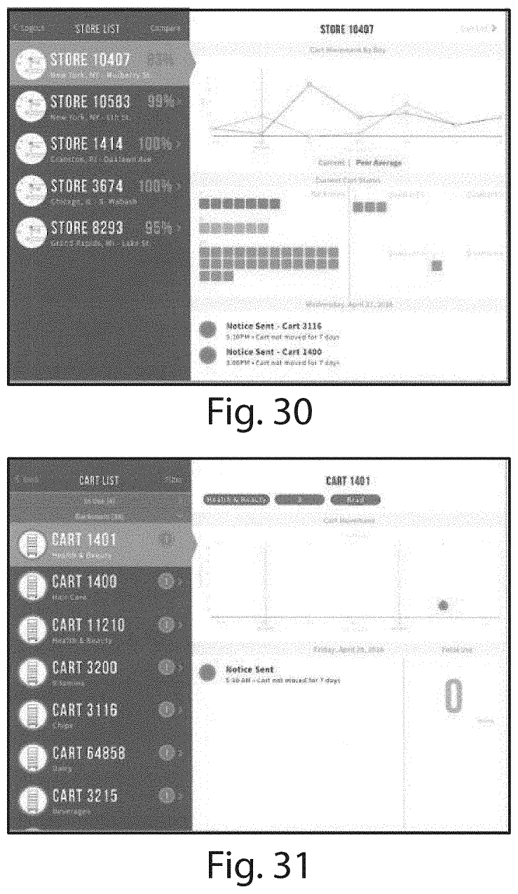

FIG. 30 shows a metrics screen for store 10407. The information charts the number of carts moved each day at store 10407 versus the number of carts moved each day at an “average” store. The current cart status for store 10407 is also presented. The number of carts with red, yellow, and green status is displayed, as well as quadrants of the store in which inventory stocking carts are located.

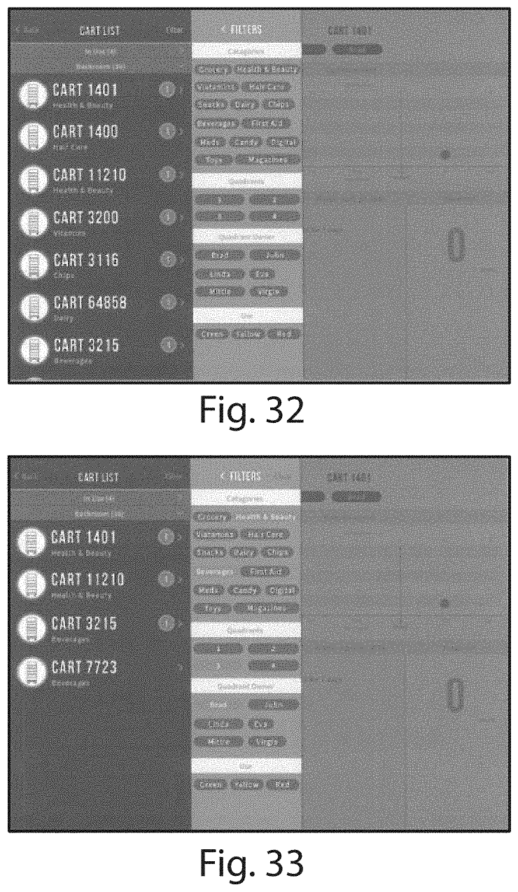

FIG. 31 shows that cart 1401, assigned to the Health & Beauty department or area, has not been moved for 7 days and that notice has been provided. The notice can be an email, text message, or other alert sent to a predefined person or persons to inform them when a certain condition is met—in this case whenever a cart has not been moved within 7 days a notice is sent. FIGS. 32-33 illustrate exemplary filters that are available for filtering information provided by the user device such as the collected tracking information or store usage information.

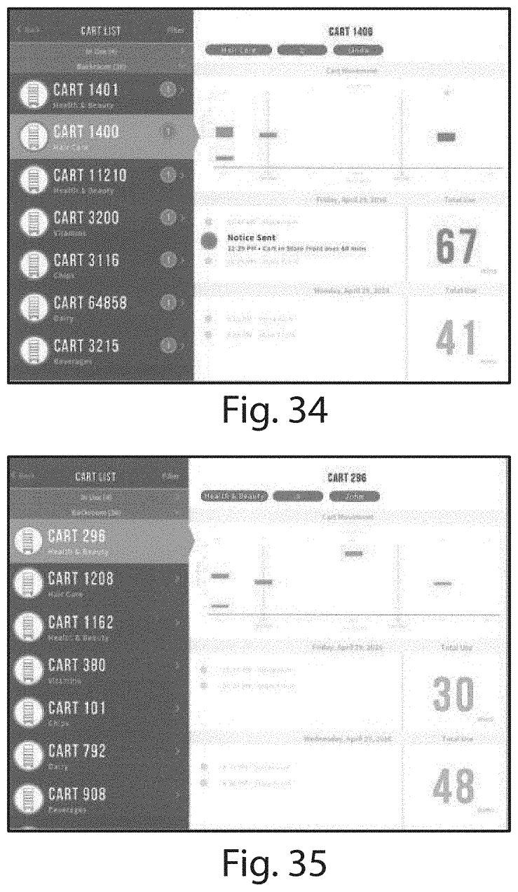

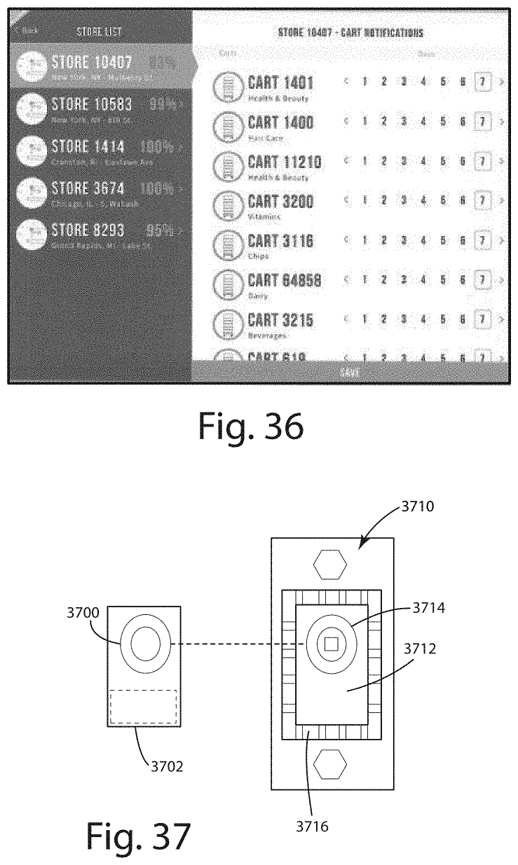

In another example, illustrated in FIG. 34, movement of cart 1400, assigned to employee Linda and the Hair Care department, is tracked throughout the week. On Monday, the cart was used for 41 minutes, in the store front and the stockroom. On Friday, the cart was used for 67 minutes, and a notice was sent because the cart was positioned in the store front for over 60 minutes. Similarly, FIG. 35 shows the movement of cart 296, assigned to John and the Health & Beauty department. FIG. 36 lists all of store 10407's carts and the configuration for each cart in regards to how long before a notification is sent due to the cart's lack of movement.

As mentioned above, according to one aspect of the system, notifications can be sent to an authority, whether that be the store manager, district manager, etc., to alert the authority to a less than desirable inventory situation. A notification system enables management to understand when carts have not been pushed, and may elevate the messaging to higher level management based on time and use. For example, a notification that a cart has not been moved in a predetermined number of days can be sent to a store manager.

FIG. 24 illustrates one embodiment of a state diagram for a user device for the inventory transport monitoring system. The user device can be updated from an inventory transport monitoring system database 2402. The information can include inventory transport locations, or data that can be used to determine inventory transport locations 2404. The inventory transport locations can be displayed visually for the user 2406. The user device can be updated 2408. The user device can have a setup mode for configuring the nodes within the system 2410. The user device can also display status information on the user device about the various nodes within the system.

Additional Assets

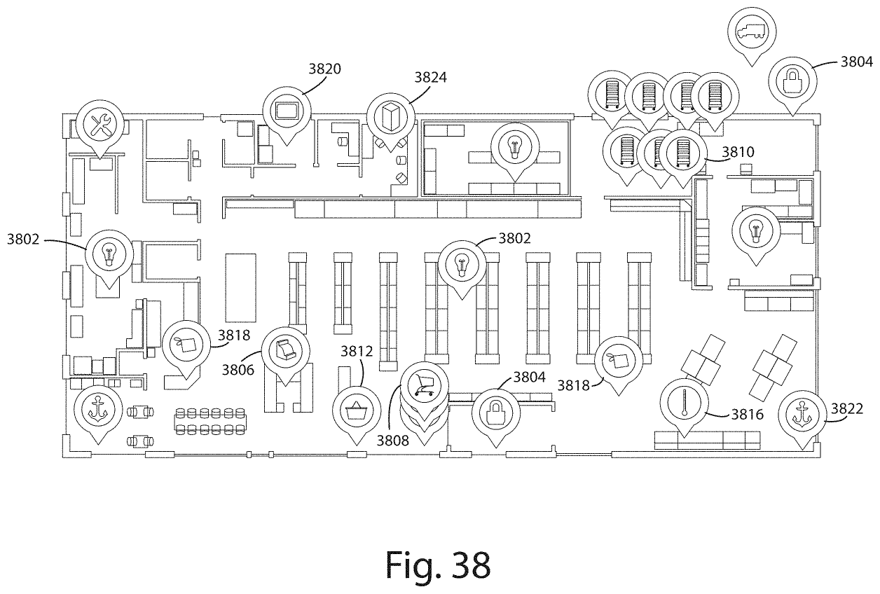

The inventory transport monitoring system can include assets in addition to tracking nodes, hub nodes, and user devices. These additional assets can collect information that can be communicated using the inventory transport monitoring system network architecture and presented to a user device. For, example, FIG. 38 shows a screen shot of a user device depicting a store layout and the position of various assets within the store. In the depicted embodiment, the assets include lights 3802, locks 3804, proximity sensors 3806, shopping carts 3808, inventory stocking carts 3810, shopping baskets 3812, cash registers 3814, temperature nodes 3816, special hub nodes 3818, user devices 3820, hub anchor or zone nodes 3822, and other hub nodes 3824. The user interface and experience can be helpful for managing store information and employee education.

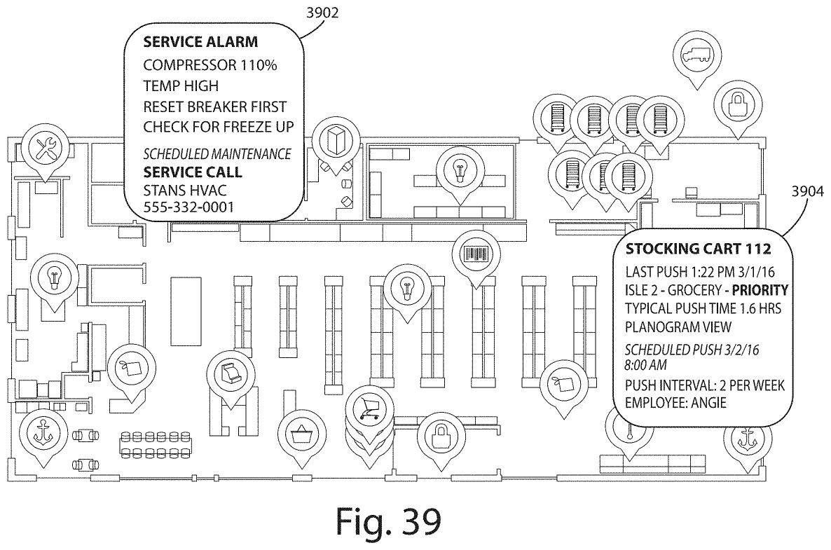

Additional detail can be provided about the various assets in an expanded view, for example as shown in the screen shot of the user device of FIG. 39. If an asset or location is selected additional information can be displayed. For example, the service alarm 3902 is selected and lists various information about the asset on the user device so that management information can be seen in one easy to see screen. Another example is the selected grocery aisle 3904, which identifies what stocking cart ID is used to stock that particular area and the various information about it including for example, the time since it was last stocked, a link to a planogram view of that aisle, the next time a stocking cart is scheduled to be pushed to stock that area, the employee assigned to that task, etc. Essentially any of the assets can include an information screen when selected that provides additional information such as phone numbers, websites, a planogram viewing link, responsible maintenance references, service information, or any other store management. This type of information can be configured at setup of the inventory transport monitoring system to be provided to the user device.

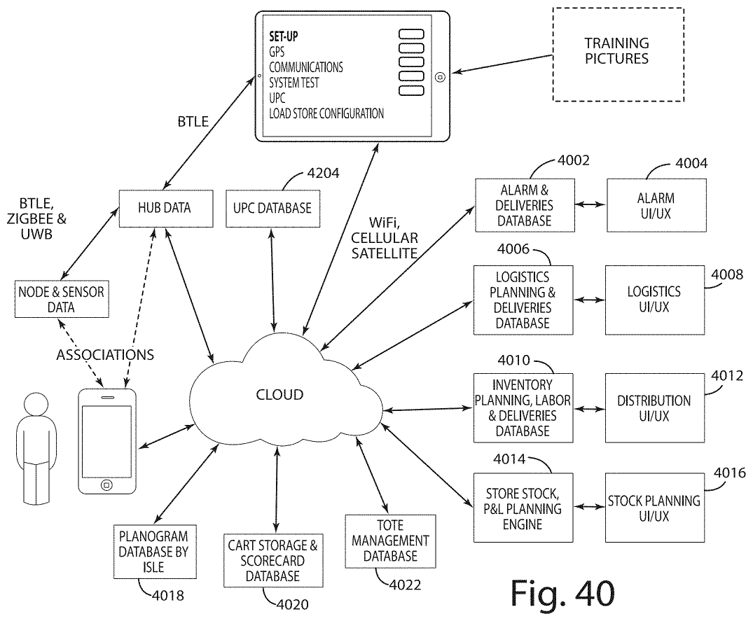

FIG. 40 shows an embodiment of an inventory transport monitoring system that includes a variety of components. The depicted embodiment includes alarm and deliveries database 4002 along with an alarm UI/UX 4004 for interfacing with the alarm system. It also includes a logistics planning and deliveries database 4006 along with a UI/UX 4008, an inventory planning, labor and deliveries database 4010 and distribution UI/UX 4012, a store stock, P&L planning engine 4014 and UI/UX 4016, a planogram database 4018, a cart storage and scorecard database 4020, a tote management database 4022, and a UPC database 4024. One or more of these, or any other auxiliary systems, can be utilized in conjunction with the inventory transport monitoring system. The cross-reference of these databases enables retail priority decision-making and staff coaching.

FIG. 40 also depicts how a user device can be utilized to set up and configure the inventory transport monitoring system. The node locations, hub locations, and calibration mode can be graphically represented. The surfacing of the node information and deeper data exchanges can be programmed An example can be the stock sensor, it can be configured with a UPC code that it is monitoring. This interface allows the user to configure the sensor and enter or scan the UPC code.

Stocking Efficiency Information

According to another embodiment of the present invention, the inventory transport monitoring system can track inventory stocking and the stocking process in an effort improve stocking efficiency and to maintain available product within the retail store. When product is absent from the store shelves, sales can be missed and thus profit can be lost. The missing product may actually be on the store premises, but not stocked because store room employees and/or management is not aware that the shelves are not stocked. An inventory management system can track when items are sold (via barcode or other method) and transmit that information to a database that where that data can be cross-referenced with information from inventory transport monitoring system.

Once a threshold number of items have been sold, those items can be flagged for restocking. A system can manage and balance pushing too many inventory stocking carts relative to keeping the shelves stocked, helping to optimize employee time spent stocking inventory. It may happen that many items need to be restocked at the same time. In this case, systematically prioritizing how and which items are restocked and in what order can increase profits. The system can provide information to help reduce the cost to serve and help managers understand opportunities for efficiency.

The system can generate priority restocking information based on different priority factors. For example, the system may suggest restocking based on the profitability of the item (large items stocked first; i.e., vacuum cleaners); least number of cart pushes required (minimize empty space on cart); distribution route (group items that belong on shelves geographically close to one another for less total cart travel time); or ease of restocking (top shelf of cart corresponds to items stocked on a top shelf (i.e., aisle 5 top shelf), middle shelf of cart corresponds to items stocked on middle shelf (i.e., aisle 2 middle shelf)).

Efficiency information may also be gathered in a variety of ways, examples of which include the following. A bar code scanner or similar supplies daily/hourly product sold to a cloud like device. A sensor tracks the volume of store traffic throughout the day, developing historic traffic information. The system, using ID signals from nodes in specific areas of the store, can then calculate the traffic over time and over cycles as related to stocking and stocking patterns. The system may include a method for calculating the best times of day to stock and prioritizing the stocking efforts of employees. Further, the system may include a device for displaying priorities and management opportunities.

Additional examples of ways to gather efficiency information include the following. Utilizing a tracking device to compare metrics between successful stores and less successful stores. A notification device to push inventory when estimated inventory would be depleted. A notification system that enables management to understand when carts have not been pushed and connected to a prioritized notification system that elevates the messaging to higher level management based on time and use. Inventory carts may include sensors to track IDs and provide tracking and movement information. A heat map of the retail store showing usage and travel so purchases can be tracked by comparing traffic of carts to consumption of product. The system can warn or point out shifts in behavior over historic data and average trends. This data can inform points of interest and stocking optimization watches. A telematics connection to an ecosystem of distribution so that product usage and changes can be tracked through the system and trucks, orders, traffic, usage and inventory can be more closely coordinated and tracked. This information provides a better understanding of shrinkage and timing of distribution, enabling ranking metrics to be put in place for maximizing efficiency and behaviors. Further, the ID tracking system may also be placed on carts and/or baskets to show traffic patterns within the store planogram to show areas of consumer interest and shifts in interest. This helps to predict consumption by traffic, location of shopping, and store activity using historic data.

The system can also help refine stock transfers and movement within the store to be conducted in more efficient ways. The way in which stock is handled and moved can be made more efficient if one understands the profit priority and volume/turns of inventory relative to time, promotions, and store traffic. For example, an inventory transfer and stocking system enables understanding of the store planogram, and items can be grouped for minimal movement and maximum efficiency. A scanning system can be used to identify totes and incoming inventory. Efficiency can be gained through a store wide understanding of the planogram map and the seasonal usage of product. The system can utilize a system for managing store maps and coordinate the transfer of products by matching shelf to shelf transfer and using inventory carts and totes. The system can understand overstock items and allow feedback to the ordering system over time; this can be a scanning device for recognizing the stock in versus out over time. Further, the system may utilize a device and application for connecting this information to the store history and historic cycles over seasonal and promotional cycles.

Using the gathered information, the system also can enable management to teach best practices to maximize business and track business metrics per employee. This allows a ranking of staff, who may then be rewarded accordingly, encouraging best practices and positive behavior while teaching such practices.

The system can track items by traffic (people in the store) and purchases (UPCs scanned) and can factor stock cycles and rates of stock into recommendations that the system makes, and over a period of time, can determine a typical stock cycle. Including store traffic in the equation enables an understanding of optimal times to stock throughout the day. A simple people traffic sensor tracking the volume of people in the store throughout the day and throughout the year can correlate traffic with volumes sold. Further, including promotions and sale items to the equation enables an understanding of trends.

Improved Battery Life

According to another embodiment of the present invention, the inventory transport monitoring system includes ways to eliminate, reduce, or minimize the cost of maintenance related to the battery life of the nodes on the inventory stocking carts. The system utilizes a simple ID system along with a device setup to identify and recognize location and accumulate locational information throughout a retail network of sensors and data collection hubs. The proximity of these multiple hubs allows the node to be ultra-low current. The low current is accomplished by time slicing an already low power RF transmission along with timed and interrupt based sensor observation over a predefined time period based on the area of present focus and resolution, as discussed above. The focus and resolution can be based on usage curves and time of use.

For example, a node can transmit data with a less granular time resolution. The system uses the hubs to form a logistical network that coordinates the transmission of information periodically, which allows power use to be decreased over time resolution. As another example of increasing battery life, the devices may be configured to only communicate during store hours. When a store is closed, for example from 10:00 pm to 8:00 am, the device can be designed to communicate only during operation hours and the off time is interrupt based. This can allow up to 50% gain in battery life, which in turn decreases the cost of maintenance in terms of batteries and service related to changing the batteries in the store. In addition to increasing battery life, battery life may be augmented through a secondary source. For example, the device may be charged or powered via wireless power.

Examples of ways to increase battery life may include the following. Time based transmission that is a characteristic of the cycle and resolution needed by the establishment. Higher volume retail environments, for example, may have more aggressive cycles. The transmission and identification cycle dictates the life of the system. The device may include a primary and secondary power source; one fixed and one that augments power using additional sources of input power that can be directed or harvested. The system may include synchronization or a system setup system that enables configuration of daily schedules to minimize transmission and power consumption, and/or an interrupt system that watches on the off time for events that are unexpected. The system may also include a time based interrupt that enables the view of acceleration and sensor input, thus minimizing the resolution of data but maximizing the efficiency of the system. A coordination system can be used to set up the time based system based on needs of that retail type, history, and volume allowing dynamic changes in these cycles as the store changes.

Another battery life improvement is to include a swappable, rechargeable system that enables the system to swap sensors while maintaining identification for that unit. The swappable battery system, shown in FIG. 37, enables simple battery replacement, replacing a discharged battery with a new, charged battery. A sealed RFID chip 3714 can be joined, affixed or otherwise mounted to an inventory transport by way of an enclosure 3710. There is a node board area 3712 in which a node 3702 can interfit. The node can be locked into a shield 3716 with a locking mechanism. The node 3702, including a battery, can be interchangeable. The node made include a wireless power coil, optionally for sealed units, used for RFID in transport. The RFID chip 3714 provides the node 3702 with information to configure the node, making the nodes rechargeable and interchangeable. The system can monitor battery life of the node and indicate which units need batteries change. The sealed RFID chip can be associated with the asset, for example the inventory transport. When a discharged node is removed and replaced with a charged node, the new node assumes the new ID and data is transferred. The old node can be recharged and used as a replacement node once it is sufficiently charged.

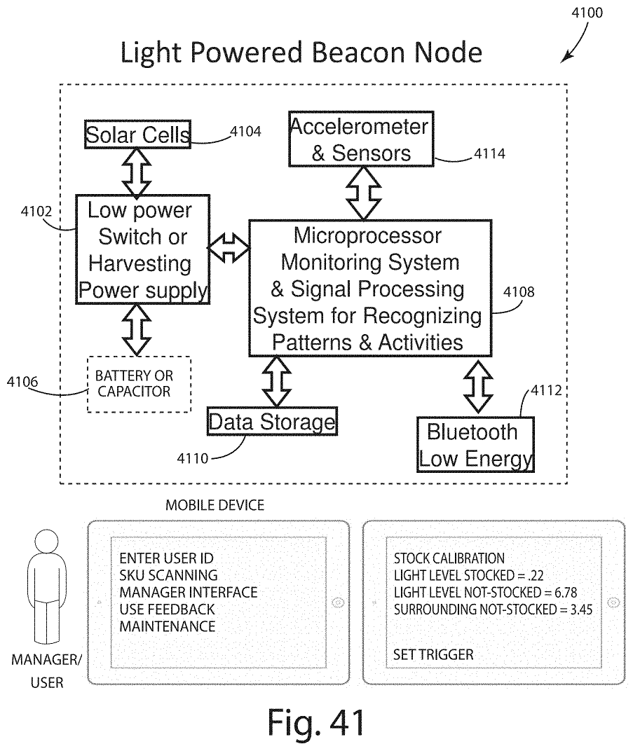

Other nodes in the system can be powered by a battery and benefit from improved battery life. In one embodiment, depicted in FIG. 41, a light enabled beacon node is provided. The light enabled beacon node 4100 includes a low power switch or power harvesting power supply 4102, one or more solar cells 4104, an electrical storage system (for example, one or more batteries or supercapacitors) 4106, a microprocessor 4108, a data storage system 4110, a Bluetooth low energy system 4112, and one or more sensors 4114. The light enabled beacon node can be associated with a product or area of products. The light enabled beacon can be installed near the back of a stocking shelf such that while product is fully or partially stocked the product blocks the light from reaching the light enabled beacon. When a sufficient amount of product has been removed from the shelves to permit a sufficient amount of light to reach the light enabled beacon, the beacon can activate and transmit a message that the shelf needs to be restocked. The light enabled beacon may optionally include a sensor, such as an accelerometer to detect tampering.

The low power switch can be a FET that responds to changes in light. In one embodiment, the switch activates to electrically connect the electrical storage system to the microprocessor in response to a threshold amount of light. The solar cells and harvesting power supply (if utilized) can be used as a detector that does not draw current from an electrical storage device and turns on the system to avoid power drain when off. In some embodiments, the solar cells or harvesting power supply may provide sufficient power to power the node any all of the electronic circuits on the node. In other embodiments, the solar cells or harvesting power supply may provide sufficient power to power the low power switch, which can connect a battery or capacitor for providing additional power to the rest of the circuitry. The microprocessor can be programmed to cause the Bluetooth Low Energy system to send a signal at a predefined rate. The power consumed while the unit is off can be limited to only the solar cell power. When the solar cell biases the switch, the primary batteries power the sensor and advertisement of the ID. The ID can be associated with the SKU and a SMS or other message can be pushed or transmitted. The accelerometer can be used to detect tampering. If the unit is biased and the node is moving a tampering alarm can be triggered via a local sound or a message to a mobile device or station.

A calibration mode allows the user to set stocked, un-stocked and partially stocked limits or thresholds for the unit to indicate and translate to the network for SKU and stocking indications. The system can take a reading with all stock in place, all stock removed but stock on both sides, with the stock on both sides removed and with stock on both sides removed and partial stock for the target item. This allows the node to make some determinations based on these preset programmed levels to make a stock assessment for the target and surrounding items. FIG. 41 also shows a peg type mounting for the stock indicator and a behind the product implementation.

Installation of a light enabled beacon node can be conducted by obtaining and associating in memory a product identifier, a beacon identifier, and a location. For example, a barcode, stock keeping unit, or other product identifier can be scanned or input into a mobile device. A beacon identifier can also be scanned or input into the mobile device. In addition, a location where the beacon will be (or already is) installed and the product will be stocked (or already is stocked) can be input into or obtained by the mobile device. These three pieces of information can be associated in memory in the system so that if the light enabled beacon activates indicating it is time for restocking, the system can identify the product that needs restocking, and where to restock that item in the store.

Restocking Priority

Sometimes items may need to be restocked at the same time—systematically prioritizing how and which items are restocked and in what order can increase profits. The inventory transport monitoring system can reduce the cost to service and help managers understand opportunities for efficiency. The system may generate priority information that can be based on different priority schemes such as: profit (large items stocked first; i.e., vacuum cleaner); least number of cart pushes (load cart to minimize empty space on cart); distribution route—grouping items that are shelved geographically close to one another for less total cart travel time; ease of restocking—top shelf of cart corresponds to items stocked on a top shelf (i.e., aisle 5 top shelf), middle shelf of cart corresponds to items stocked on middle shelf (i.e., aisle 2 middle shelf), etc.

The inventory transport monitoring system may include a barcode scanner and a database of daily/hourly product sales information, a sensor for tracking the volume of store traffic throughout the day for developing historic traffic information, and a system for calculating the traffic over time and over cycles as it relates to stocking and stocking patterns. The system may also include a method for calculating the best times of day to stock the shelves, and prioritizing the stocking efforts with employees.

Analytics

The system allows coaching store managers and provides store analytics to better understand and define successful and unsuccessful management practices. These analytics are then used to share best practices, examples, and content. The performance of stores lower on the distribution curve can be coached to perform like top performing stores.

Information shared may include:
coaching reminders of best practices;
priority inventory practices;
comparison between stores;
how am I performing compared to stores like mine, with performance tips;
clear effort path for district manager conversations;
district coaching—notes to up-lines about opportunities;
backroom cart organization suggestions—planograms;
better hiring practices by showing best employee types;
empowered team with dashboards;
what employees are moving with the carts (employee performance metrics);
understanding efficiency of employees;
store training opportunities with an interactive device;
accountability for the management team;
inspiring employees to go the extra mile through optimal planning and communications;
staff reminders and dashboard priorities;
Store traffic to stocking need;
Cost and time of stocking by traffic; and
Optimal stocking times and opportunities by traffic and staff.

The system may also include: a tracking device that compares metrics between successful stores and less successful stores; a notification device to push inventory when estimated inventory would be depleted; a notification system that enables management to understand when carts have not been pushed; and the notification system being connected to a prioritized notification system that elevates the messaging to higher level management based on time and use.

Stores that do not implement these coached practices, the up-line manager may get a notification. The notification may be a SMS, email, or web-link automatically generated. For example, if an inventory cart is not moved in one week, the store manager gets a message. If the inventory cart is not moved in two weeks, the area manager gets a message; in three weeks, the regional manager gets a message; and in four weeks the corporate headquarters gets a message. All of these actions result in coaching and automated coaching opportunities.

Zone Proximity Detection

Practical issues can complicate location determination efforts. For example, attenuation, tolerances, signal reflections, collisions, and multitudes of other issues can cause a variety of issues in determining a precise location. In some situations, accurately determining that an inventory transport is within a certain zone is preferable to determining specific location with less accuracy. For example, in one embodiment, inventory transports are tracked in a storefront. Determining whether each cart is on the storefront floor or in the backroom can be a useful characteristic.

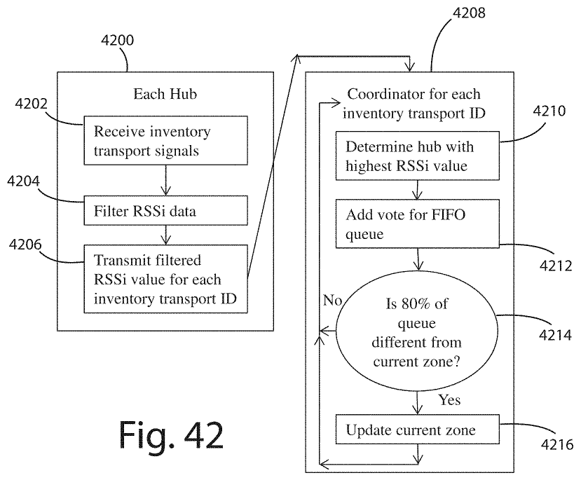

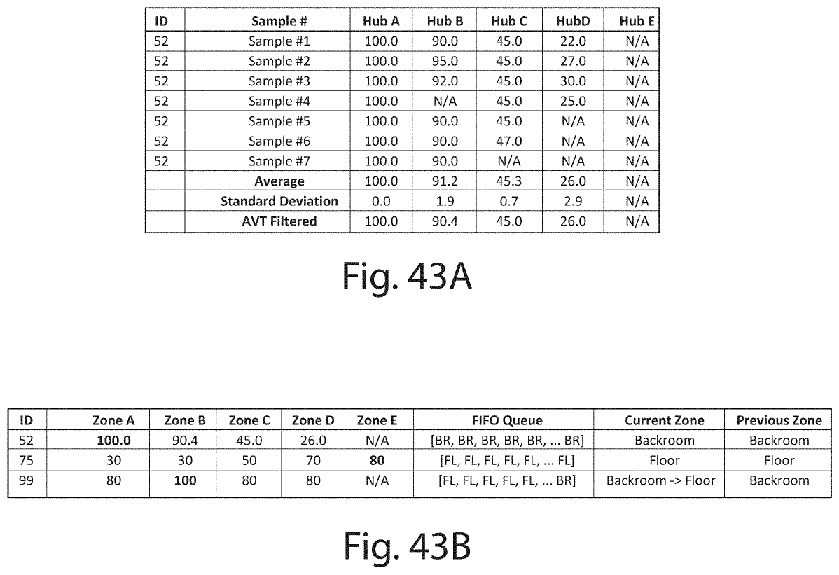

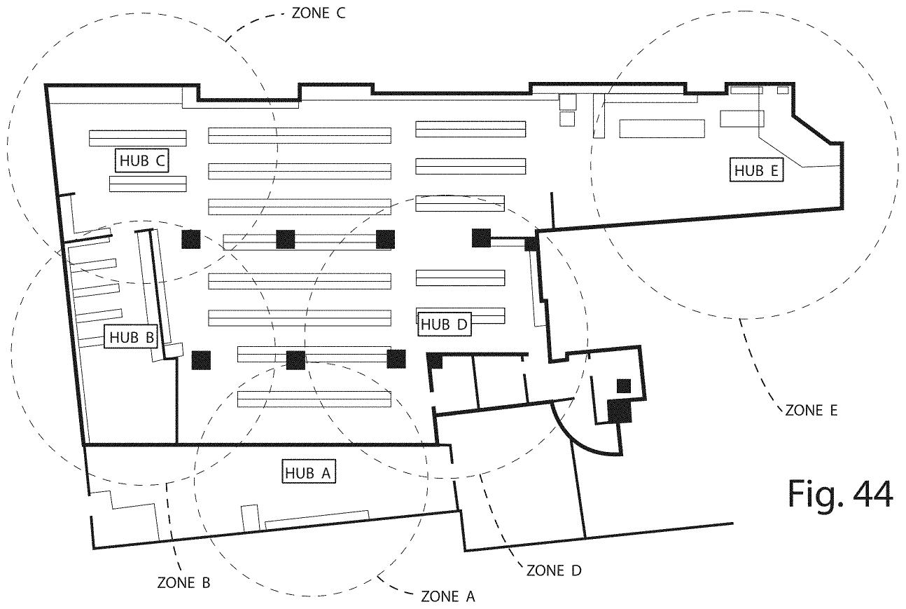

FIGS. 42-44 illustrate one exemplary embodiment for tracking whether inventory transports are in the storefront floor or in the backroom. FIG. 42 shows an exemplary flowchart for this method. FIG. 43A shows representative data associated with the hubs A, B, C, D, E. FIG. 43B shows representative data associated with the coordinator. FIG. 44 shows an exemplary store layout with Hubs A, B, C, D, E each respectively associated with zones A, B, C, D, E.

The various inventory transport nodes periodically each transmit signals, such as Bluetooth advertising signals. Each hub A, B, C, D, E that is within range of the signals receives them and processes the signals 4202. In the current embodiment, that processing includes determining an RSSi value and filtering the data 4204.

Bluetooth RSSi values can have a tolerance that is representative of plus or minus 10 feet in distance indication. One way to improve the accuracy of the location data is to collect multiple samples and use statistical analysis. In one embodiment, each hub listens to all inventory transport node signals for a predetermined amount of time, for example 10 seconds. The hub calculates the mean RSSi and standard deviation for each signal ID within that time of whatever samples it received. A statistical analysis can be done to filter the samples. For example, an Antonyan Vardan Transform (AVT) can be done to improve the quality of raw data s shown FIG. 43A,

As shown in FIG. 43A, each hub may receive multiple signals from each inventory transport node ID, which are referred to as samples. Although not depicted for simplicities sake, each hub may receive multiple signals from multiple inventory transport node IDs. FIG. 43A shows the samples collected over one 10 second period for one inventory tracking node ID. In the given example, some of the hubs receive: 7 RSSi samples, while others receive fewer or none. There is a variety of reasons that hubs may receive different numbers of samples, including collisions, attenuation, reflection, etc.

In this example, the Hub filters RSSi signals captured in a 10 second window before sending on a value to the coordinator. The Hubs need not be synchronized in transmitting their data to the coordinator. Peudocode for implementing the AVT filtering is provided below:
np_values=numpy.array(self_rssi_values[address])
# First calculate the mean and standard deviation
average=numpy.average(np_values)
std_dev=numpy.std(np_values)
# Filter out any values outside of 1 standard deviation from the mean and re-average
avt_mask=(np_values[:]>=(average-std_dev)) & (np_values[:]<=(average+std_dev))
avt_average=numpy.average(np_values, weights=avt_mask)

Referring back to the flowchart of FIG. 42, once each hub has filtered the data 4204, it transmits a filtered RSSi value for each inventory transport ID from which it received at least one sample of signal during that period. In alternative embodiments, the hub may be configured to only provide a filtered RSSi value if a threshold number of samples of RSSi signals are received during a given period.

For simplicities sake representative data is shown in FIG. 43B. This data shows that the coordinator received data in connection with three inventory tracking nodes IDs 52, 75, and 99. The coordinator 4208 is configured to process the filtered RSSi values and update the zone location of each inventory transport node as appropriate. For each inventory transport node ID, the coordinator determines the hub with the highest RSSi value 4210 and adds a vote for that hub to a first-in-first-out queue 4212. If a certain threshold percentage of the votes in the queue, for example 80%, are for a different zone than the current zone stored in memory for that inventory transport, then the current zone is updated. If not, then the process begins again, for example once sufficient data has been received from the hubs.

The hubs are not required to synchronize their transmissions. The coordinator can continually add new votes to the queue whenever it receives updated data. The coordinator does not need to compare data that was just received. Instead, the coordinator can compare the last known RSSi value for that inventory tracking node ID to determine the zone vote. The system may include a timer for discarding data that is stale, for example if an RSSi value is older than two minutes, it may be discarded.

The FIFO queue can be essentially any length. In the current embodiment the queue is 60 slots. This voting system helps to ensure that the current zone is not changed until the system is confident that the inventory transport node has changed locations. With this system in place, the system does not prematurely indicate that the inventory transport has changed zones. Further, the system will not sporadically show an inventory transport flipping between locations when it is between two hubs that have overlapping zones.

By assigning each zone to represent the store floor or backroom, the FIFO queue can be utilized to determine whether an inventory tracking node is on the store floor or backroom. In the embodiment depicted in FIG. 44, Hub A is in the backroom, while Hubs B, C, D, and E are all in the storefront. Accordingly, Zone A represents the backroom, while zones B, C, D, and E represent the store front. By way of example, as depicted in connection with FIG. 43, ID 99 has just undergone a transition. The coordinator determines that Zone B has the highest RSSi, and therefore adds a floor “FL” designator to the FIFO queue. The FIFO queue for ID 99 before this designator was added included 47 floor “FL” designators and 23 backroom “BR” designators. The last designator in the queue was a backroom “BR” designator and will be pushed out of the queue by the addition of the new floor “FL” designator. This will change the balance to 48 floor “FL” designators and 22 backroom “BR” designators. 48 of 60 designators is 80% of the queue and enough to trigger a change. Accordingly, the coordinator will copy the current zone to the previous zone field and then update the current zone to the floor designator. This information can then be displayed on the user interface of the application to indicate the change in position of the inventory tracking cart with ID 99.

While the zones B, C, D, E can be mapped to a single larger zone, such as is this case in the embodiment discussed above where these four zones each are mapped to the “storefront” zone, these zones need not be mapped this way. Instead, for example, these zones may represent separate zones in the storefront and the data can be presented to the user at a more granular level. For example, instead of voting between backroom and storefront, the system can be configured to vote between the backroom, zone B, zone C, zone D, and zone E. The various thresholds within the system can be adjusted as appropriate. For example, it may be more difficult to reach an 80% threshold of votes in a system with more zones. To address this issue, the system may be configured to utilize a plurality vote to determine the zone if the current location is not present in the FIFO queue. For example, if the inventory tracking node is located in the store in a position that gives somewhat similar values between two or more nodes, due to noise and tolerances the votes may flip back and forth between those two or more nodes making it so no single node has enough votes. However, if this additional configuration operation is included, then the system will determine the zone to be whichever zone has the plurality of votes in the queue as long as the current zone location is not anywhere in the queue. This ensures that if you move from the backroom (zone A) to a spot on the floor between two nodes, for example between zone C and zone D, the system will still change the current zone to either zone C or zone D, but will not flip between zone C and zone D.

The above description is that of a current embodiment of the invention. Various alterations and changes can be made without departing from the spirit and broader aspects of the invention as defined in the appended claims, which are to be interpreted in accordance with the principles of patent law including the doctrine of equivalents.

This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims.

1. An inventory transport monitoring system for a store, the system comprising:
a plurality of hubs positioned throughout the store, each of said plurality of hubs including a communication system;
a plurality of inventory transports for moving inventory within the store, each of said plurality of inventory transports including a tracking device having a communication system;
a coordinator configured to receive tracking information regarding said plurality of inventory transports and to determine which of a plurality of zones each inventory transport is located based on the tracking information; and
a database for storing said information regarding said plurality of inventory transports including the determined zone in which each inventory transport is located.

2. The inventory transport monitoring system of claim 1 wherein each tracking device of each of said plurality of inventory transports includes a sensor system.

3. The inventory transport monitoring system of claim 2 wherein said sensor system includes an accelerometer.

4. The inventory transport monitoring system of claim 2 wherein said sensor system includes a ranging system for determining distance to at least one of said plurality of hubs.

5. The inventory transport monitoring system of claim 1 wherein at least a subset of said plurality of hubs are zone hubs that each define different zones within the store.

6. The inventory transport monitoring system of claim 5 wherein at least a different subset of said plurality of hubs are subzone hubs that define subzones within the zones.

7. The inventory transport monitoring system of claim 1 including a processor configured to analyze said tracking information to determine a path of movement for each of said plurality of inventory transports through the store, wherein said path of movement is displayed on a user device.

8. The inventory transport monitoring system of claim 1 including a processor configured to analyze said tracking information to determine a heat map for the store based on said tracking information, wherein said heat map is displayed on a user device.

9. The inventory transport monitoring system of claim 1 including a processor configured to analyze said tracking information to determine inventory transport status information for each of said plurality of inventory transports, wherein said inventory transport status information is displayed on a user device.

10. A system for monitoring and comparing inventory transport characteristics among a plurality of stores, the system comprising:
a plurality of inventory transport monitoring systems each installed at a different corresponding one of the plurality of stores;
a database for storing information from said plurality of inventory transport monitoring systems;
a processor configured to identify and track successful retail store characteristics and efficiency based on said information from said plurality of inventory transport monitoring system;
wherein each of said plurality of inventory transport monitoring systems includes:
a plurality of hubs positioned throughout the corresponding store, each of said plurality of hubs being associated with one of a plurality of zones and each of said plurality of hubs including a communication system;
a plurality of inventory transport tracking devices installed on a plurality of inventory transports used for moving inventory within the store, each of said tracking devices having a communication system;
a coordinator configured to receive tracking information from said plurality of hubs regarding said plurality of inventory transports, to determine which of the plurality of zones each inventory transport is located based on the tracking information, and to communicate said tracking information to said database.

11. The inventory transport monitoring system of claim 10 wherein each inventory transport tracking device includes a sensor system.

12. The inventory transport monitoring system of claim 11 wherein said sensor system includes an accelerometer.

13. The inventory transport monitoring system of claim 11 wherein said sensor system includes a ranging system for determining distance to at least one of said plurality of hubs.

14. The inventory transport monitoring system of claim 10 wherein at least a subset of said plurality of hubs are zone hubs that each define different zones within the store.

15. The inventory transport monitoring system of claim 14 wherein at least a different subset of said plurality of hubs are subzone hubs that define subzones within the zones.

16. The inventory transport monitoring system of claim 10 including a processor configured to analyze said tracking information to determine a path of movement for each of said plurality of inventory transports through the store, wherein said path of movement is displayed on a user device.

17. The inventory transport monitoring system of claim 10 including a processor configured to analyze said tracking information to determine a heat map for the store based on said tracking information, wherein said heat map is displayed on a user device.

18. The inventory transport monitoring system of claim 10 including a processor configured to analyze said tracking information to determine inventory transport status information for each of said plurality of inventory transports, wherein said inventory transport status information is displayed on a user device.

19. A method for improving a store, the method comprising:
tracking, with an inventory management system, inventory information for each of the plurality of stores;
at each store, flagging an item for restocking in response to inventory information indicating a threshold number of the item has been sold according to a restocking priority scheme;
tracking with an inventory transport monitoring system at each store, inventory transport characteristics for a plurality of inventory transports at each of the plurality of stores including a restocking route of each inventory transport;
categorizing, based on profitability, each of the one or more of the plurality of stores as successful or unsuccessful;
changing at least one characteristic of a store categorized as unsuccessful to correspond to a characteristic of a successful store.

20. The method for improving a store of claim 19 wherein changing at least one characteristic of a store categorized as unsuccessful to correspond to a characteristic of a successful store includes changing a restocking priority scheme of the store categorized as unsuccessful to correspond to the restocking priority scheme of the store categorized as successful.

21. The method for improving a store of claim 19 wherein changing at least one characteristic of a store categorized as unsuccessful to correspond to a characteristic of a successful store includes changing a restocking route of one or more of the plurality of inventory transports of the store categorized as unsuccessful to correspond to the restocking route of one or more of the plurality of inventory transports of the store categorized as successful.
